(19) United States
(12) Patent Application Publication
(10) Pub. No.: US 2026/0336233 A1
(43) Pub. Date: Oct. 29, 2026

(54) ROLLER COMPACTORS

(71) Applicant: The Boeing Company, Arlington, VA (US)

(72) Inventors: Luis F. Velasquez, Ladson, SC (US); Edward R. Duncan, Goose Creek, SC (US)

(21) Appl. No.: 19/187,707

(22) Filed: Apr. 23, 2025

(51) Int. Cl. B29C 70/50; B29C 43/46

(52) U.S. Cl. CPC B29C 70/504; B29C 43/46

(57) ABSTRACT

A roller compactor and methods of controlling compaction of a composite material are presented. A roller compactor comprises a first portion of a compaction surface formed of a first material; and a second portion of the compaction surface formed of a second material having a lower hardness than the first material, wherein the second portion is configured to selectively reduce compaction pressure by the second portion of the compaction surface.

### BACKGROUND INFORMATION

### 1. Field

The present disclosure relates generally to composite manufacturing and more specifically to compacting composite material.

### 2. Background

A composite structure is typically formed by placing plies or layers of composite material on a forming tool that sets forth the shape and/or contour of the composite structure. Once placed, composite material is then consolidated and/or cured to form the composite structure. However, known techniques for transporting a composite material to a forming tool, placing a composite material on a forming tool, and consolidating a composite material on a forming tool may be labor-intensive and time-consuming. Additionally, depending upon the degree of contour and geometry of the composite structure, special handling may be used to prevent introduction of wrinkles or other inconsistencies during transfer and placement of the composite material.

Therefore, it would be desirable to have a method and apparatus that takes into account at least some of the issues discussed above, as well as other possible issues.

### SUMMARY

An embodiment of the present disclosure provides a roller compactor. The roller compactor comprises a first portion of a compaction surface formed of a first material; and a second portion of the compaction surface formed of a second material having a lower hardness than the first material, wherein the second portion is configured to selectively reduce compaction pressure by the second portion of the compaction surface.

Another embodiment of the present disclosure provides a method of compacting a composite material. A roller compactor is rolled along a compaction path such that a compaction surface of the roller compactor is in contact with a composite material, the compaction surface comprising a first portion formed of a first material and a second portion formed of a second material having a lower hardness than the first material. A reduced compaction pressure is applied to the composite material by the second portion of the compaction surface.

Yet another embodiment of the present disclosure provides a method of controlling compaction pressure of a roller compactor. A first portion of a compaction surface of the roller compactor is formed from a first material. A second portion of the compaction surface of the roller compactor is formed from a second material having a lower hardness than the first material.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIGS. 2A and 2B are an illustration of a block diagram of a manufacturing environment in accordance with an illustrative embodiment;

FIGS. 3A and 3B are illustrations of a block diagram of a manufacturing environment in accordance with an illustrative embodiment;

FIG. 4 is an illustration of an isometric view of a compactor in accordance with an illustrative embodiment;

FIG. 5 is an illustration of a cross-sectional view of a compactor in accordance with an illustrative embodiment;

FIG. 6 is an illustration of an isometric view of a compactor in accordance with an illustrative embodiment;

FIG. 7 is an illustration of an isometric view of a compactor in accordance with an illustrative embodiment;

FIG. 8 is an illustration of an isometric view of a compactor in accordance with an illustrative embodiment;

FIG. 9 is an illustration of a cross-sectional view of an elongate composite member that can be compacted by a compactor in accordance with an illustrative embodiment;

FIG. 10 is an illustration of a simplified side view of a compactor in accordance with an illustrative embodiment;

FIG. 11 is a flowchart of a method of compacting a composite material in accordance with an illustrative embodiment;

FIG. 12 is a flowchart of a method of controlling compaction pressure of a roller compactor in accordance with an illustrative embodiment;

FIG. 13 is a flowchart of a method of compacting a composite material in accordance with an illustrative embodiment;

FIG. 14 is a flowchart of a method of compacting a composite material in accordance with an illustrative embodiment;

FIG. 15 is a flowchart of a method of selectively forming wrinkles in a composite material during forming in accordance with an illustrative embodiment;

FIG. 16 is an illustration of an aircraft manufacturing and service method in a form of a block diagram in accordance with an illustrative embodiment; and

FIG. 17 is an illustration of an aircraft in a form of a block diagram in which an illustrative embodiment may be implemented.

### DETAILED DESCRIPTION

The illustrative examples recognize and take into account several considerations. The illustrative examples recognize and take into account that current manufacturing for elongate composite members comprises manual placement of the elongate composite member into forming and cure tool by operators. The illustrative examples recognize and take into account that currently elongate composite members are compacted against the forming and cure tool using vacuum compaction. The illustrative examples recognize and take into account that currently unique elongate compactors are used for each elongate composite member cross-section. The illustrative examples recognize and take into account that currently unique elongate compactors are used for each elongate composite member.

The illustrative examples recognize and take into account that currently used vacuum compactors may utilize additional compaction supplied by another operator or component. The illustrative examples provide a rolling compaction end effector for a contour forming sequence. The illustrative examples provide a rolling compaction end effector configured to provide sufficient continuous compaction during the process. The illustrative examples provide a rolling compaction end effector that can be used to progressively seat the elongate composite member into place and compact the elongate composite member.

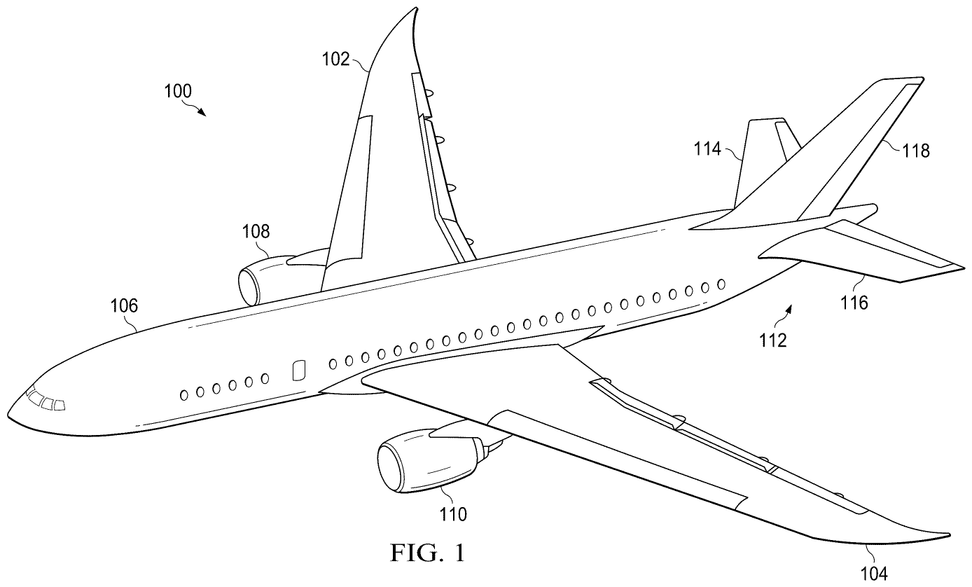

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have elongate composite structures compacted using a roller compactor of the illustrative examples. A composite stiffener of at least one of wing 102, wing 104, or body 106 can be compacted by a roller compactor of the illustrative examples.

Although the illustrative examples are described with respect to an aircraft, an illustrative embodiment may be applied to other types of platforms. The platform may be, for example, a mobile platform, a stationary platform, a land-based structure, an aquatic-based structure, or a space-based structure. More specifically, the platform, may be a surface ship, a tank, a personnel carrier, a train, a spacecraft, a space station, a satellite, a submarine, an automobile, a power plant, a house, a manufacturing facility, a building, a refinery, a chemical containment unit, fuel tank, passenger cabin, or other suitable platforms.

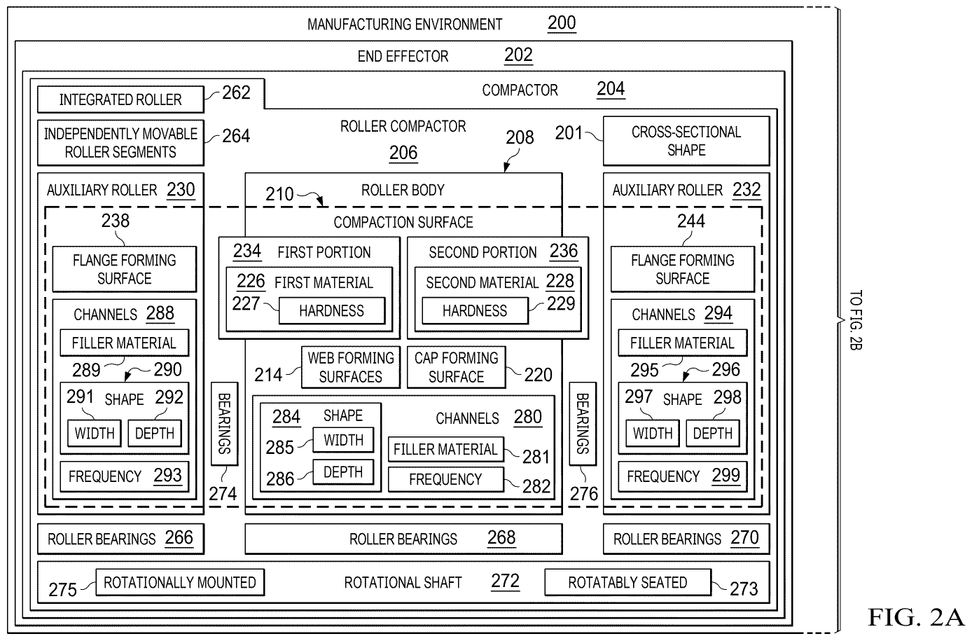

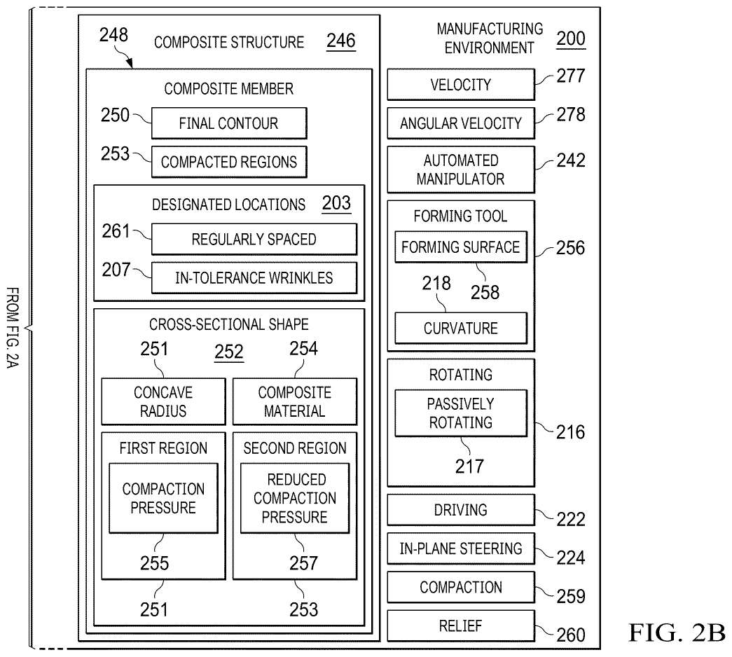

Turning now to FIGS. 2A and 2B, an illustration of a block diagram of a manufacturing environment is depicted in accordance with an illustrative embodiment. A composite member of aircraft 100 of FIG. 1 can be compacted by roller compactor 206 of FIGS. 2A and 2B. Roller compactor 206 can be used to compact composite material 254 onto forming tool 256.

In this illustrative example, roller compactor 206 comprises compaction surface 210 configured to contact composite material 254. During operation, roller compactor 206 applies compressive forces to composite material 254 as roller compactor 206 moves along a compaction path. During operation, roller compactor 206 applies compressive forces to composite material 254 while compaction surface 210 is in contact with the composite material 254.

Roller compactor 206 comprises any desirable number of features to provide desirable compaction of composite member 248 and reduce undesirable inconsistencies in resulting composite structure 246. In some illustrative examples, roller compactor 206 comprises a multi-material compaction surface 210 to control application of compressive forces. In some illustrative examples, roller compactor 206 comprises independently movable roller segments 264 to maintain velocity 277 as a constant while angular velocity 278 is dependent on a size and shape of a portion of roller compactor 206. In some illustrative examples, roller compactor 206 comprises channels 280 in compaction surface 210 to provide localized relief 260 from compaction 259. Any desirable combination of at least one of different materials, channels 280, or independently movable roller segments 264 forming compaction surface 210 can reduce inconsistencies in composite member 248. In some illustrative examples, composite member 248 can be referred to as an elongate composite member.

In some illustrative examples, roller compactor 206 comprises first portion 234 of compaction surface 210 formed of first material 226, and second portion 236 of compaction surface 210 formed of second material 228 having a lower hardness than first material 226. In this illustrative example, first material 226 has hardness 227 and second material 228 has hardness 229. In this illustrative example, hardness 227 is greater than hardness 229. Second portion 236 is configured to selectively reduce compaction pressure by second portion 236 of roller body 208. By selectively reducing compaction pressure of second portion 236, pressure applied by first portion 234 is greater than pressure applied by second portion 236. In some illustrative examples, second portion 236 is selected to locally relax compaction 259 outside of concave radius 251 of cross-sectional shape 252 of composite material 254 to intensify compaction 259 in concave radius 251.

In some illustrative examples, compaction surface 210 is complementary to cross-sectional shape 252 of composite member 248. In some illustrative examples, compaction surface 210 is complementary to forming surface 258 of forming tool 256. In some illustrative examples, cross-sectional shape 201 of roller compactor 206 is complementary to cross-sectional shape 252 of composite member 248.

In some illustrative examples, second portion 236 is selected to reduce compaction inconsistencies in a composite material 254 compacted by rolling roller compactor 206 over composite material 254. In some illustrative examples, at least one of second material 228 or second portion 236 are selected to reduce compaction inconsistencies such as wrinkles, gaps, or bridging.

In some illustrative examples, first portion 234 of compaction surface 210 comprises web forming surfaces 214, and wherein second portion 236 of compaction surface 210 comprises cap forming surface 220. In some illustrative examples, a size and a shape of cap forming surface 220 are configured to reduce bridging in composite member 248.

In some illustrative examples, first material 226 and second material 228 are configured to provide sufficient friction with composite material 254 being compacted to passively roll roller compactor 206 about rotational shaft 272. In these illustrative examples, end effector 202 will be driven along a compaction path by a manipulator, such as automated manipulator 242, such that compaction surface 210 of compactor 204 is in contact with composite material 254 of composite member 248.

The multi-material design of roller compactor 206 with at least first material 226 and second material 228 allows for variable stiffness along a contact profile, allowing compaction pressure to be locally intensified or relaxed in different regions. When composite member 248 comprises a composite stringer, variable stiffness enables additional compaction at web/cap radii for increasing quality and reducing or preventing inconsistencies due to bridging/wrinkles. Second material 228 with lower hardness will provide reduced compaction pressure 257. First material 226 with greater hardness will provide more compaction pressure, compaction pressure 255.

Roller compactor 206 comprising first material 226 and second material 228 can comprise either integrated roller 262 or independently movable roller segments 264. When roller compactor 206 is integrated roller 262, all portions of compaction surface 210 are connected. When roller compactor 206 is integrated roller 262, all portions of compaction surface 210 move about rotational shaft 272 together. When roller compactor 206 comprises independently movable roller segments 264, compaction surface 210 is formed of segments that can be moved independently of each other.

In some illustrative examples, roller compactor 206 is configured to compact composite material 254 and comprises rotational shaft 272, roller body 208 rotatably seated 273 on rotational shaft 272, and auxiliary roller 230 rotatably seated 273 on rotational shaft 272 such that auxiliary roller 230 is independently movable relative to roller body 208.

In some illustrative examples, roller compactor 206 further comprises roller bearings 268 between roller body 208 and rotational shaft 272. In some illustrative examples, roller compactor 206 further comprises bearings 274 between roller body 208 and auxiliary roller 230.

In some illustrative examples, roller body 208 has first diameter 237, wherein auxiliary roller 230 has first diameter 239 different from first diameter 237. In some illustrative examples, first diameter 237 is larger than first diameter 239.

In some illustrative examples, roller compactor 206 further comprises roller bearings 266 between auxiliary roller 230 and rotational shaft 272.

In some illustrative examples, roller body 208 and auxiliary roller 230 are configured to have a same velocity 277 at a forming surface and different angular velocity 278 while maintaining compaction 259 with desirable levels of friction.

When roller compactor 206 comprises independently movable roller segments 264, compactor 204 is a segmented roller for reducing or preventing differential rotational surface velocity friction effects. Independently movable roller segments 264 reduce effects due to differential rotational surface velocity. Independently movable roller segments 264 reduce effects due to variable radius in design profile of roller compactor 206. Independently movable roller segments 264 reduce effects due to variable angular velocity 278 during in-plane steering 224 through curvature 218 of a compaction path. The curvature matches final contour 250 of composite member 248.

Through curvature 218, an outer roller, such as one of auxiliary roller 230 or auxiliary roller 232, will have a greater angular velocity 278 than an inside roller, such as the other of auxiliary roller 230 or auxiliary roller 232. In some illustrative examples, passively rotating 217 independently movable roller segments 264 at different angular velocities comprises rotating 216 independently movable roller segments 264 at different angular velocities due to driving 222 roller compactor 206 with in-plane steering 224 through curvature 218.

In this illustrative example, each roller segment of independently movable roller segments 264 has its own roller bearings to enable independent rotation on a common shaft, rotational shaft 272. Bearings at mating interfaces, bearings 274 and bearings 276, between roller segments prevent friction/binding due to differential angular velocity 278 between adjacent segments. In some illustrative examples, the bearings at mating surfaces are needle bearings.

In some illustrative examples, roller compactor 206 is configured to compact composite material 254 and comprises roller body 208 having first diameter 237, and auxiliary roller 230 adjacent roller body 208, auxiliary roller 230 having first diameter 239 different from first diameter 237 of roller body 208 and independently movable relative to roller body 208 such that auxiliary roller 230 can have a different angular velocity 278 as roller body 208.

In some illustrative examples, first diameter 239 is smaller than first diameter 237. In some illustrative examples, roller body 208 and auxiliary roller 230 are rotationally mounted 275 to a same rotational shaft, rotational shaft 272.

In some illustrative examples, roller compactor 206 further comprises roller bearings 266 between auxiliary roller 230 and rotational shaft 272. In some illustrative examples, roller compactor 206 further comprises bearings 274 between roller body 208 and auxiliary roller 230. In some illustrative examples, roller body 208 comprises web forming surfaces 214 and cap forming surface 220 for composite member 248. In some illustrative examples, auxiliary roller 230 comprises flange forming surface 238.

In some illustrative examples, roller compactor 206 further comprises auxiliary roller 232. In some illustrative examples, roller compactor 206 further comprises roller bearings 270 between auxiliary roller 232 and rotational shaft 272. In some illustrative examples, roller compactor 206 further comprises bearings 276 between roller body 208 and auxiliary roller 232. In some illustrative examples, auxiliary roller 232 comprises flange forming surface 244.

In some illustrative examples, channels 280 along roller compactor 206 profile allow compaction relief functionality during continuous rolling compaction. Channels 280 can be uniformly distributed along the circumference of roller compactor 206. Width 285 of channels 280 could be modified as desired for improved forming quality.

In some illustrative examples, roller compactor 206 comprises compaction surface 210 configured to contact composite material 254, and channels 280 extending across at least a portion of compaction surface 210. In some illustrative examples, channels 280 are present in roller body 208.

In some illustrative examples, channels 280 extend continuously across compaction surface 210. In some illustrative examples, channels 280 are discontinuous on compaction surface 210. In some illustrative examples, depth 286 of channels 280 vary across compaction surface 210. In some illustrative examples, at least one channel of channels 280 has depth 286 that varies. In some illustrative examples, at least one channel of channels 280 has a different depth 286 than other channels. In some illustrative examples, depth 286 is selected such that channels 280 maintain relief 260 while compaction 259 is applied to composite material 254. In some illustrative examples, depth 286 is sufficient such that material of roller compactor 206 beneath channels 280 does not contact composite material 254.

In some illustrative examples, width 285 of channels 280 vary across compaction surface 210. In some illustrative examples, at least one channel of channels 280 has a different width 285 than other channels. In some illustrative examples, at least one channel of channels 280 has width 285 that varies along the respective channel. In some illustrative examples, each channel of channels 280 has a same width 285.

In some illustrative examples, channels 280 are substantially straight. In other illustrative examples, channels 280 are curved.

In some illustrative examples, channels 280 are configured to locally provide relief 260 from compaction 259. In some illustrative examples, at least one channel of channels 280 comprises filler material 281 in the respective channel. Filler material 281 comprises any desirable material having a compliance configured to tailor a compaction applied to composite material 254.

In some illustrative examples, roller compactor 206 further comprises filler material 281 within at least one channel of channels 280, wherein filler material 281 has a lower hardness than first material 226 of compaction surface 210. In some illustrative examples, filler material 281 is a polymer. In some illustrative examples, filler material 281 is silicone.

In some illustrative examples, compaction surface 210 comprises cap forming surface 220, web forming surfaces 214 opposite cap forming surface 220, and flange forming surfaces, flange forming surface 238 and flange forming surface 244, adjacent web forming surfaces 214, and wherein channels 288 or channels 294 extending across at least a portion of the flange forming surfaces have at least one of a different width, a different frequency, or a different depth than channels 280 of web forming surfaces 214.

In this illustrative example, channels 288 in flange forming surface 238 have shape 290 including width 291 and depth 292. In some illustrative examples, width 291 and depth 292 are the same as width 285 and depth 286 of channels 280. In some illustrative examples, at least one of width 291 or depth 292 are different than width 285 and depth 286 of channels 280.

In this illustrative example, channels 288 in flange forming surface 238 have frequency 293. In some illustrative examples, frequency 293 is the same as frequency 282. In some illustrative examples, frequency 293 is different from frequency 282. In some illustrative examples, frequency 293 and frequency 282 can be described in terms of an angular measurement of the cross-section of flange forming surface 238. In some illustrative examples, frequency 293 and frequency 282 can be described in terms of a physical distance across compaction surface 210. In some illustrative examples, channels 288 in flange forming surface 238 comprise filler material 289.

In some illustrative examples, channels 280 comprise more than one set of channels, wherein each set of channels has a respective shape. In some illustrative examples, by having a different shape 284, at least one of width 285, depth 286, or path across compaction surface 210 is different.

In this illustrative example, channels 294 in flange forming surface 244 have shape 296 including width 297 and depth 298. In some illustrative examples, width 297 and depth 298 are the same as width 285 and depth 286 of channels 280. In some illustrative examples, at least one of width 297 or depth 298 are different than width 285 and depth 286 of channels 280.

In this illustrative example, channels 294 in flange forming surface 244 have frequency 299. In some illustrative examples, frequency 299 is the same as frequency 282. In some illustrative examples, frequency 299 is different from frequency 282. In some illustrative examples, frequency 299 and frequency 282 can be described in terms of an angular measurement of the cross-section of flange forming surface 244. In some illustrative examples, frequency 299 and frequency 282 can be described in terms of a physical distance across compaction surface 210. In some illustrative examples, channels 294 in flange forming surface 244 comprise filler material 295.

In some illustrative examples, channels 280 comprise more than one set of channels, wherein each set of channels has a respective shape. In some illustrative examples, by having a different shape 284, at least one of width 285, depth 286, or path across compaction surface 210 is different.

In some illustrative examples, compacted regions 253 are formed in composite material 254 during forming of composite material 254. In some illustrative examples, in-tolerance wrinkles 207 are located in designated locations 203 between compacted regions 253 of composite material 254. In some illustrative examples, in-tolerance wrinkles 207 are located in designated locations 203 comprises providing relief 260 from compaction 259 in designated locations 203 during the forming of composite material 254. In some illustrative examples, locating in-tolerance wrinkles 207 in designated locations 203 comprises allowing formation of in-tolerance wrinkles 207 within regularly spaced 261 designated locations 203 between compacted regions 253.

The illustration of manufacturing environment 200 in FIGS. 2A and 2B is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

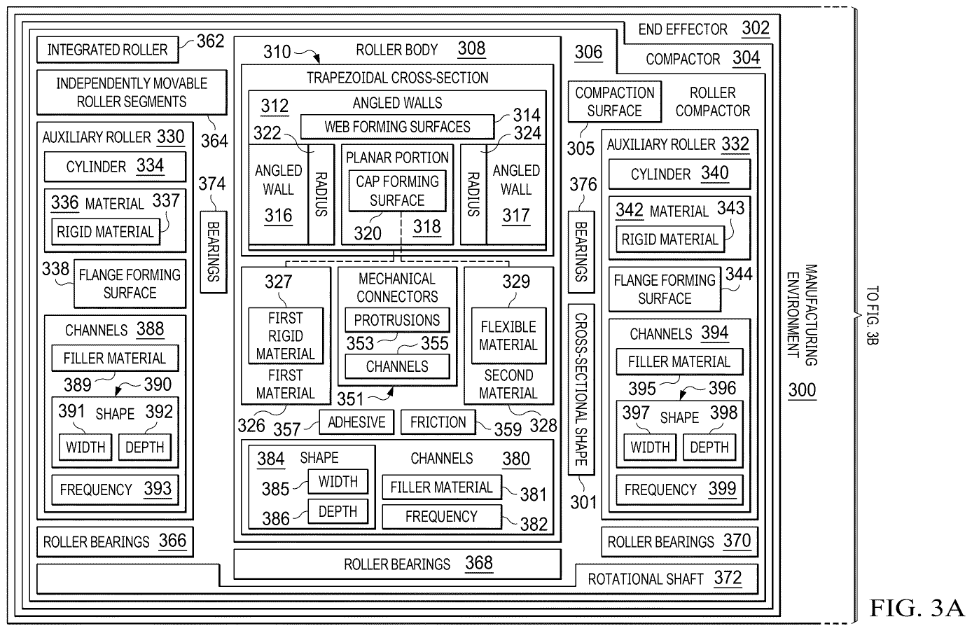

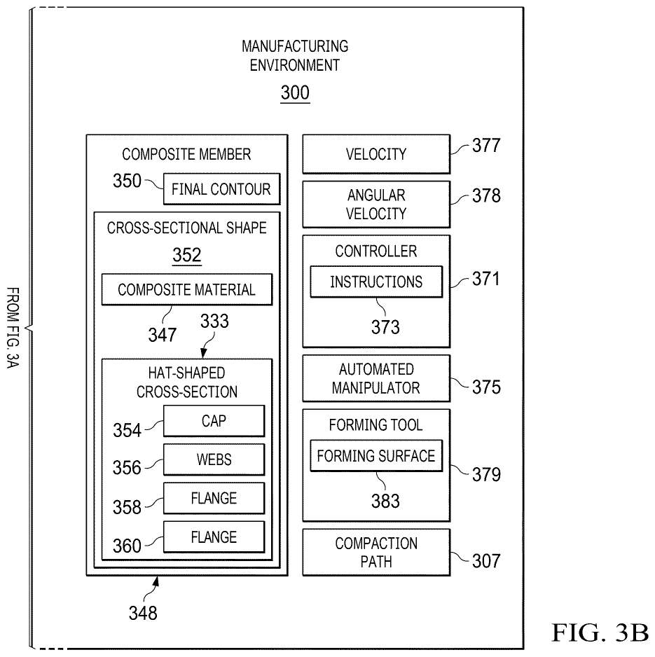

Turning now to FIGS. 3A and 3B, an illustration of a block diagram of a manufacturing environment is depicted in accordance with an illustrative embodiment. A composite member of aircraft 100 of FIG. 1 can be compacted by roller compactor 306 of FIGS. 3A and 3B. In some illustrative examples, roller compactor 306 is an example of roller compactor 206. Roller compactor 306 can be used to compact composite material 347 onto forming tool 379.

Composite member 348 comprises composite material 347 that is in a “green” state. Composite material 347 is formable as composite material 347 is uncured or partially cured.

In this illustrative example, roller compactor 306 comprises compaction surface 305 configured to contact composite material 347. During operation, roller compactor 306 applies compressive forces to composite material 347 as roller compactor 306 moves along compaction path 307. Compaction path 307 is followed to compact composite member 348 having final contour 350.

During operation, roller compactor 306 applies compressive forces to composite material 347 while compaction surface 305 is in contact with composite material 347.

In some illustrative examples, composite member 348 can take the form of a composite stringer or composite stiffener. In some illustrative examples, composite member 348 can be referred to as an elongate composite member. Composite member 348 has cross-sectional shape 352. In some illustrative examples, cross-sectional shape 352 can be hat-shaped cross-section 333. Hat-shaped cross-section 333 comprises cap 354 between webs 356 and flanges, flange 358 and flange 360, adjacent webs 356.

Roller compactor 306 is configured to apply a desired amount of compaction pressure against composite material 347 throughout cross-sectional shape 352 of composite member 348. Roller compactor 306 is configured to apply a desired amount of compaction pressure against composite material 347 as roller compactor 306 compacts composite member 348 in final contour 350. In some illustrative examples, final contour 350 comprises twists or curves along the length of composite member 348.

Roller compactor 306 comprises any desirable number of features to provide desirable compaction of composite member 348 and reduce undesirable inconsistencies in a resulting composite structure. In some illustrative examples, roller compactor 306 comprises a multi-material compaction surface 305 to control application of compressive forces. In some illustrative examples, roller compactor 306 comprises independently movable roller segments 364 to maintain velocity 377 as a constant while angular velocity 378 is dependent on a size and shape of a portion of roller compactor 306. In some illustrative examples, roller compactor 306 comprises channels in compaction surface 305 to provide localized relief from compaction. Any desirable combination of at least one of different materials, channels, or independently movable roller segments forming compaction surface 305 can reduce inconsistencies in elongate composite member.

In some illustrative examples, roller compactor 306 comprises a first portion of compaction surface 305 formed of first material 326, and a second portion of compaction surface 305 formed of second material 328 having a lower hardness than first material 326. The second portion is configured to selectively reduce compaction pressure by the second portion of roller body 308.

In some illustrative examples, first material 326 can be referred to as a rigid material or first rigid material 327. First material 326 has a greater durometer hardness than second material 328. In some illustrative examples, second material 328 is referred to as a compliant material or flexible material 329. In this illustrative example, although two materials with different durometer hardness are depicted, in other illustrative examples, more than two materials can be used. In some illustrative examples, compactor 304 can comprise more than two materials with different durometer hardnesses. In some illustrative examples, the material of compaction surface 305 can be tailored based on desired compaction and cross-sectional shape 352 of composite material 347 to be compacted. In some illustrative examples, first material 326 has a range of hardnesses. In some illustrative examples, second material 328 has a different range of hardnesses.

When composite member 348 has hat-shaped cross-section 333, roller compactor 306 comprises cap forming surface 320, web forming surfaces 314, flange forming surface 338, and flange forming surface 344. In some illustrative examples, web forming surfaces 314 are formed by angled walls 312. In some illustrative examples, cap forming surface 320 comprises planar portion 318 between angled wall 316 of angled walls 312 and angled wall 317 of angled walls 312. As depicted, angled wall 316 is connected to planar portion 318 by radius 322. As depicted, angled wall 317 is connected to planar portion 318 by radius 324. Flange forming surface 344 is connected to angled wall 317. Flange forming surface 338 is connected to angled wall 316.

In some illustrative examples, compaction surface 305 is complementary to cross-sectional shape 352 of composite member 348. In some illustrative examples, compaction surface 305 is complementary to forming surface 383 of forming tool 379. In this illustrative example, forming surface 383 is configured to support composite member 348 having cross-sectional shape 352 and final contour 350.

In some illustrative examples, second portion is selected to reduce compaction inconsistencies in a composite material 347 compacted by rolling roller compactor 306 over composite material 347. In some illustrative examples, at least one of second material 328 or second portion are selected to reduce compaction inconsistencies such as wrinkles, gaps, or bridging. In some illustrative examples, at least one of a size, a shape, and a position of the second portion formed of second material 328 are selected based on cross-sectional shape 352 of composite member 348. In some illustrative examples, second material 328 is selected to tailor compaction pressure to portions of cross-sectional shape 352 of composite member 348.

In some illustrative examples, the first portion of compaction surface 305 comprises web forming surfaces 314, and the second portion of compaction surface 305 comprises cap forming surface 320. In these illustrative examples, cap forming surface 320 is more compliant than web forming surfaces 314. In some illustrative examples, roller compactor 306 comprises radiuses between web forming surfaces 314 and cap forming surface 320, wherein the radiuses, radius 322 and radius 324, are formed of first material 326. In some illustrative examples, compliance of cap forming surface 320 allows for radius 322 and radius 324 formed of first material 326 to provide increased compaction pressure. In some illustrative examples, compliance of cap forming surface 320 allows for cap forming surface 320 to provide reduced compaction pressure. In some illustrative examples, a size and a shape of cap forming surface 320 are configured to reduce bridging in composite member 348.

Roller body 308 can comprise any desirable cross-section configured to compact cross-sectional shape 352 of composite member 348. In some illustrative examples, roller body 308 comprises trapezoidal cross-section 310 including web forming surfaces 314 and cap forming surface 320. In other illustrative examples, roller body 308 comprises a number of curved surfaces. In some illustrative examples, flange forming surfaces are not present. In some illustrative examples, cap forming surface 320 is not planar.

First material 326 and second material 328 can be joined in any desirable fashion. In some illustrative examples, roller body 308 is three-dimensionally printed. In some illustrative examples, first material 326 and second material 328 are three-dimensionally printed together. In some illustrative examples, second material 328 can be joined to first material 326 by adhesive 357 between first material 326 and second material 328. In some illustrative examples, second material 328 is restrained against first material 326 by friction 359. In some illustrative examples, mechanical connectors 351 maintain second material 328 on first material 326. In some illustrative examples, mechanical connectors 351 can be referred to as mechanical restraints.

In some illustrative examples, mechanical connectors 351 comprise protrusions 353 formed of first material 326, and channels 355 in second material 328 positioned over protrusions 353 to secure second material 328 to first material 326. In some illustrative examples, mechanical connectors 351 comprise protrusions 353 formed of second material 328, and channels 355 in first material 326 receiving protrusions 353 to secure second material 328 to first material 326. In some illustrative examples, mechanical connectors 351 comprise a combination of channels 355 and protrusions 353 formed of second material 328 configured to interface with a combination of channels 355 and protrusions 353 in first material 326 to secure second material 328 to first material 326.

In some illustrative examples, first material 326 and second material 328 are configured to provide sufficient friction with composite material 347 being compacted to passively roll roller compactor 306 about rotational shaft 372. In these illustrative examples, end effector 302 will be driven along compaction path 307 by a manipulator, such as automated manipulator 375, such that compaction surface 305 of compactor 304 is in contact with composite material 347 of composite member 348. Application of pressure by end effector 302 and movement along compaction path 307 generates movement of roller compactor 306 due to friction.

The multi-material design of roller compactor 306 with at least first material 326 and second material 328 allows for variable stiffness along a contact profile, allowing compaction pressure to be locally intensified or relaxed in different regions. When composite member 348 comprises a composite stringer, variable stiffness enables additional compaction at web/cap radii for increasing quality and reducing or preventing inconsistencies due to bridging/wrinkles. Second material 328 with lower hardness will provide less compaction pressure. First material 326 with greater hardness will provide more compaction pressure.

Roller compactor 306 comprising first material 326 and second material 328 can comprise either integrated roller 362 or independently movable roller segments 364. When roller compactor 306 is integrated roller 362, all portions of compaction surface 305 are connected. When roller compactor 306 is integrated roller 362, all portions of compaction surface 305 move about rotational shaft 372 together. When roller compactor 306 comprises independently movable roller segments 364, compaction surface 305 is formed of segments that can be moved independently of each other.

In some illustrative examples, roller compactor 306 is configured to compact a composite material 347 and comprises rotational shaft 372, roller body 308 rotatably seated on rotational shaft 372, and auxiliary roller 330 rotatably seated on rotational shaft 372 such that auxiliary roller 330 is independently movable relative to roller body 308. In some illustrative examples, roller compactor 306 further comprises auxiliary roller 332 rotatably seated on rotational shaft 372 such that auxiliary roller 332 is independently movable relative to roller body 308.

In some illustrative examples, roller compactor 306 further comprises roller bearings 368 between roller body 308 and rotational shaft 372. Roller bearings 368 enable rotation of roller body 308 about rotational shaft 372.

In some illustrative examples, roller compactor 306 further comprises bearings 374 between roller body 308 and auxiliary roller 330. In some illustrative examples, roller compactor 306 further comprises bearings 376 between roller body 308 and auxiliary roller 332. Bearings 374 ease independent movement of auxiliary roller 330 and roller body 308 relative to each other. Bearings 376 ease independent movement of auxiliary roller 332 and roller body 308 relative to each other.

In some illustrative examples, roller body 308 has a first diameter, wherein auxiliary roller 330 has a second diameter different from the first diameter. In some illustrative examples, roller body 308 has a first diameter, wherein auxiliary roller 332 has a second diameter different from the first diameter. In some illustrative examples, the first diameter is larger than the second diameter.

In some illustrative examples, auxiliary roller 330 comprises cylinder 334. In some illustrative examples, auxiliary roller 332 comprises cylinder 340.

Auxiliary roller 330 comprises material 336. In some illustrative examples, material 336 can be referred to as rigid material 337. Auxiliary roller 332 comprises material 342. In some illustrative examples, material 342 can be referred to as rigid material 343. In some illustrative examples, compaction surface 305 including auxiliary roller 330 and auxiliary roller 332 are formed of first material 326. In this illustrative example, material 336 and material 342 are the same as first material 326. In some illustrative examples, compaction surface 305 is formed of more than one material. In some illustrative examples, at least one of material 336 or material 342 is different from first material 326 of roller body 308.

In some illustrative examples, roller body 308 and auxiliary roller 330 are configured to have same velocity 377 at forming surface 383 and different angular velocity 378 while maintaining compaction with desirable levels of friction. In some illustrative examples, roller body 308 and auxiliary roller 332 are configured to have same velocity 377 at forming surface 383 and different angular velocity 378 while maintaining compaction with desirable levels of friction.

When roller compactor 306 comprises independently movable roller segments 364, compactor 304 is a segmented roller for reducing or preventing differential rotational surface velocity friction effects. Independently movable roller segments 364 reduce effects due to differential rotational surface velocity. Independently movable roller segments 364 reduce effects due to variable radius in design profile of roller compactor 306. Independently movable roller segments 364 reduce effects due to variable angular velocity 378 during in-plane steering through curvature of compaction path 307. Through curvature, an outer roller, such as one of auxiliary roller 330 or auxiliary roller 332, will have a greater angular velocity 378 than an inside roller, such as the other of auxiliary roller 330 or auxiliary roller 332.

In this illustrative example, each roller segment of independently movable roller segments 364 has its own roller bearings to enable independent rotation on a common shaft, rotational shaft 372. Bearings at mating interfaces, bearings 374 and bearings 376, between roller segments prevent friction/binding due to differential angular velocity 378 between adjacent segments. In some illustrative examples, the bearings at mating surfaces are needle bearings.

In some illustrative examples, roller compactor 306 is configured to compact a composite material 347 and comprises roller body 308 having a first diameter, and auxiliary roller 330 adjacent roller body 308, auxiliary roller 330 having a second diameter different from first diameter of roller body 308 and independently movable relative to roller body 308 such that auxiliary roller 330 can have a different angular velocity 378 as roller body 308.

In some illustrative examples, compaction surface 305 of roller compactor 306 with independently movable roller segments 364 comprises one material. In some illustrative examples, compaction surface 305 of roller compactor 306 with independently movable roller segments 364 comprises more than one material to tailor compaction.

In some illustrative examples, channels 380 along roller compactor 306 profile allow compaction relief functionality during continuous rolling compaction. Channels 380 can be uniformly distributed along the circumference of roller compactor 306. Width 385 of channels 380 could be modified as desired for improved forming quality.

In some illustrative examples, roller compactor 306 comprises compaction surface 305 configured to contact composite material 347, and channels 380 extending across at least a portion of compaction surface 305. In some illustrative examples, channels 380 are present in roller body 308.

In some illustrative examples, channels 380 extend continuously across compaction surface 305. In some illustrative examples, channels 380 are discontinuous on compaction surface 305. In some illustrative examples, depth 386 of channels 380 vary across compaction surface 305. In some illustrative examples, at least one channel of channels 380 has depth 386 that varies. In some illustrative examples, at least one channel of channels 380 has a different depth 386 than other channels.

In some illustrative examples, width 385 of channels 380 vary across compaction surface 305. In some illustrative examples, at least one channel of channels 380 has a different width 385 than other channels. In some illustrative examples, at least one channel of channels 380 has width 385 that varies along the respective channel. In some illustrative examples, each channel of channels 380 has a same width 385.

In some illustrative examples, channels 380 are substantially straight. In other illustrative examples, channels 380 are curved.

In some illustrative examples, channels 380 are configured to locally provide relief from compaction. In some illustrative examples, at least one channel of channels 380 comprises filler material 381 in the respective channel. Filler material 381 comprises any desirable material having a compliance configured to tailor a compaction applied to composite material 347. In some illustrative examples, roller compactor 306 further comprises filler material 381 within at least one channel of channels 380, wherein filler material 381 has a lower hardness than first material 326 of compaction surface 305. In some illustrative examples, filler material 381 is a polymer. In some illustrative examples, filler material 381 is silicone.

In some illustrative examples, compaction surface 305 comprises cap forming surface 320, web forming surfaces 314 opposite cap forming surface 320, and flange forming surfaces, flange forming surface 338 and flange forming surface 344, adjacent web forming surfaces 314, and wherein channels 388 or channels 394 extending across at least a portion of the flange forming surfaces have at least one of a different width, a different frequency, or a different depth than channels 380 of web forming surfaces 314.

In this illustrative example, channels 388 in flange forming surface 338 have shape 390 including width 391 and depth 392. In some illustrative examples, width 391 and depth 392 are the same as width 385 and depth 386 of channels 380. In some illustrative examples, at least one of width 391 or depth 392 are different than width 385 and depth 386 of channels 380.

In this illustrative example, channels 388 in flange forming surface 338 have frequency 393. In some illustrative examples, frequency 393 is the same as frequency 382. In some illustrative examples, frequency 393 is different from frequency 382. In some illustrative examples, frequency 393 and frequency 382 can be described in terms of an angular measurement of the cross-section of flange forming surface 338. In some illustrative examples, frequency 393 and frequency 382 can be described in terms of a physical distance across compaction surface 305. In some illustrative examples, channels 388 in flange forming surface 338 comprise filler material 389.

In some illustrative examples, channels 380 comprise more than one set of channels, wherein each set of channels has a respective shape. In some illustrative examples, by having a different shape 384, at least one of width 385, depth 386, or path across compaction surface 305 is different.

In this illustrative example, channels 394 in flange forming surface 344 have shape 396 including width 397 and depth 398. In some illustrative examples, width 397 and depth 398 are the same as width 385 and depth 386 of channels 380. In some illustrative examples, at least one of width 397 or depth 398 are different than width 385 and depth 386 of channels 380.

In this illustrative example, channels 394 in flange forming surface 344 have frequency 399. In some illustrative examples, frequency 399 is the same as frequency 382. In some illustrative examples, frequency 399 is different from frequency 382. In some illustrative examples, frequency 399 and frequency 382 can be described in terms of an angular measurement of the cross-section of flange forming surface 344. In some illustrative examples, frequency 399 and frequency 382 can be described in terms of a physical distance across compaction surface 305. In some illustrative examples, channels 394 in flange forming surface 344 comprise filler material 395.

In some illustrative examples, channels 380 comprise more than one set of channels, wherein each set of channels has a respective shape. In some illustrative examples, by having a different shape 384, at least one of width 385, depth 386, or path across compaction surface 305 is different.

In some illustrative examples, roller compactor 306 further comprises filler material 381 within at least one channel of channels 380, wherein filler material 381 has a lower hardness than first material 326 of compaction surface 305. In some illustrative examples, filler material 381 is a polymer. In some illustrative examples, filler material 381 is silicone.

In some illustrative examples, channels 380 have a width 385 in range of 0.05 inch to 0.3 inch. In some illustrative examples, channels 380 have a width 385 in range of 0.1 inch to 0.2 inch. In some illustrative examples, channels 380 have frequency 382 of one channel approximately every 45 degrees of a cross-sectional view perpendicular to a rotational axis of roller compactor 306.

In some illustrative examples, roller compactor 306 comprises compaction surface 305 configured to contact a composite material 347, and channels 380 in at least a portion of compaction surface 305, wherein channels 380 are configured to locally provide relief from compaction. Providing relief from compaction can reduce or eliminate inconsistencies in compacting composite member 348.

In some illustrative examples, roller compactor 306 with channels 380 comprises integrated roller 362.

In some illustrative examples, roller compactor 306 with channels 380 comprises independently movable roller segments 364. In some illustrative examples, roller compactor 306 with channels 380 comprises more than one material forming compaction surface 305.

The illustration of manufacturing environment 300 in FIGS. 3A and 3B is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, composite member 348 can have cross-sectional shape 352 different from hat-shaped cross-section 333. In some illustrative examples, compaction surface 305 comprises additional forming surfaces. In some illustrative examples, compaction surface 305 has fewer forming surfaces than those depicted.

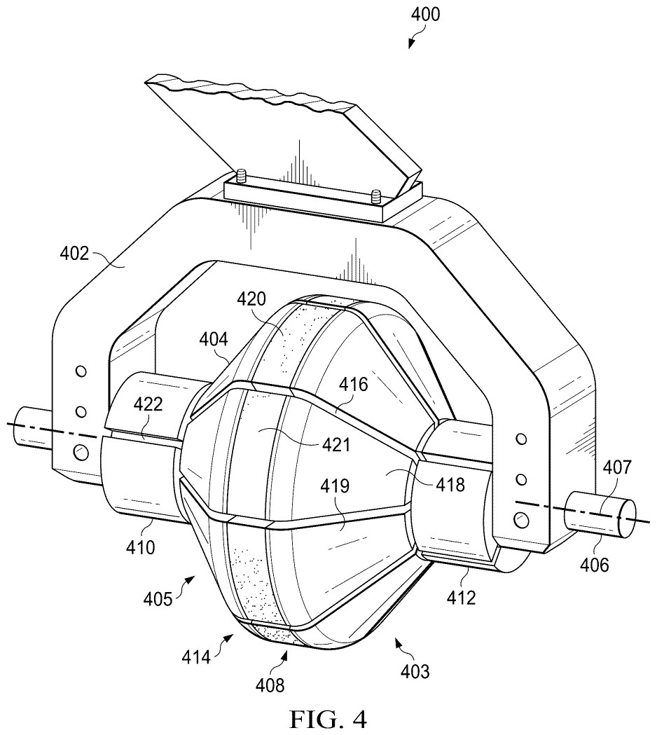

Turning now to FIG. 4, an illustration of an isometric view of a compactor is depicted in accordance with an illustrative embodiment. Compactor 404 can be used to compact a composite material in manufacturing a component of aircraft 100 of FIG. 1. Compactor 404 is a physical implementation of compactor 204 of FIGS. 2A and 2B. Compactor 404 is a physical implementation of compactor 304 of FIGS. 3A and 3B.

In view 400, compactor 404 is connected to end effector 402. In this illustrative example, compactor 404 comprises roller compactor 405. Roller compactor 405 comprises independently movable roller segments 403.

Compactor 404 comprises roller body 408 rotatably mounted on rotational shaft 406. In this illustrative example, compactor 404 further comprises auxiliary roller 410 adjacent roller body 408. In this illustrative example, compactor 404 further comprises auxiliary roller 412 adjacent roller body 408.

In this illustrative example, roller compactor 405 comprises compaction surface 414 configured to contact a composite material. During operation, roller compactor 405 applies compressive forces to the composite material as the roller compactor 405 moves along a compaction path. During operation, roller compactor 405 applies compressive forces to the composite material while compaction surface 414 is in contact with the composite material.

Roller compactor 405 comprises several features to provide desirable compaction of an elongate composite member and reduce undesirable inconsistencies in a resulting composite structure. In this illustrative example, roller compactor 405 comprises a multi-material compaction surface 414 to control application of compressive forces.

In this illustrative example, roller compactor 405 comprises first portion 419 of compaction surface 414 formed of first material 418, and second portion 421 of compaction surface 414 formed of second material 420 having a lower hardness than first material 418. Second portion 421 is configured to selectively reduce compaction pressure by second portion 421 of compaction surface 414. In some illustrative examples, first material 418 is referred to as a rigid material. In some illustrative examples, second material 420 is referred to as a compliant material.

In this illustrative example, roller compactor 405 comprises compaction surface 414 configured to contact a composite material, and channels 416 extending across at least a portion of compaction surface 414. In this illustrative example, channels 416 extend substantially parallel to a cross-sectional shape of the elongate composite member. In this illustrative example, channels 416 extend substantially perpendicular to the direction of movement of roller compactor 405. In this illustrative example, channels 416 extend through both first material 418 and second material 420. Channels 416 provide for selective relief during compaction of a composite material. Channels 416 provide for compaction of a composite member with reduced inconsistencies including reduced wrinkling.

In this illustrative example, channels 416 extend continuously across roller body 408. In this illustrative example, channels 416 extend continuously across a portion of compaction surface 414. In this illustrative example, channels 416 are discontinuous across compaction surface 414 as channels 422 in auxiliary roller 410 are different in at least one of frequency or size from channels 416 in roller body 408. In this illustrative example, channels 416 and channels 422 form two sets of channels having two different frequencies. For example, the distances between channels 416 in roller body 408 are different than the distances between channels 422 in auxiliary roller 410. Although channels 416 and channels 422 have different frequencies, channels 416 and channels 422 can have the same widths and the same depths.

In some illustrative examples, depths of channels 416 vary across compaction surface 414. In some illustrative examples, depths of channels 422 vary across compaction surface 414. Although the widths of channels 416 are continuous across compaction surface 414, in some illustrative examples, widths of channels 416 vary across compaction surface 414. Although the widths of channels 422 are continuous across compaction surface 414, in some illustrative examples, widths of channels 422 vary across compaction surface 414.

In this illustrative example, channels 416 are substantially linear across compaction surface 414. In this illustrative example, channels 422 are substantially linear across compaction surface 414. However, in other illustrative examples, channels, such as at least one channel of either channels 416 or channels 422, can be curved. In other illustrative examples, channels, including channels 416 and channels 422, can have any desirable width, depth, frequency, and angle across compaction surface 414. In some illustrative examples, channels, such as channels 416, have a frequency of one channel approximately every 45 degrees of a cross-sectional view perpendicular to rotational axis 417 of roller compactor 405.

In this illustrative example, roller compactor 405 configured to compact a composite material comprises rotational shaft 406, roller body 408 rotatably seated on rotational shaft 406, and auxiliary roller 410 rotatably seated on rotational shaft 406 such that auxiliary roller 410 is independently movable relative to roller body 408. In this illustrative example, roller compactor 405 further comprises auxiliary roller 412 rotatably seated on rotational shaft 406 such that auxiliary roller 412 is independently movable relative to roller body 408. In this illustrative example, by having independently movable roller segments 403, roller compactor 405 can have different angular velocities for auxiliary roller 410 and roller body 408 while maintaining a single velocity for roller compactor 405 over a composite member. In some illustrative examples, roller compactor 405 provides for compaction of a composite member with reduced inconsistencies including reduced wrinkling.

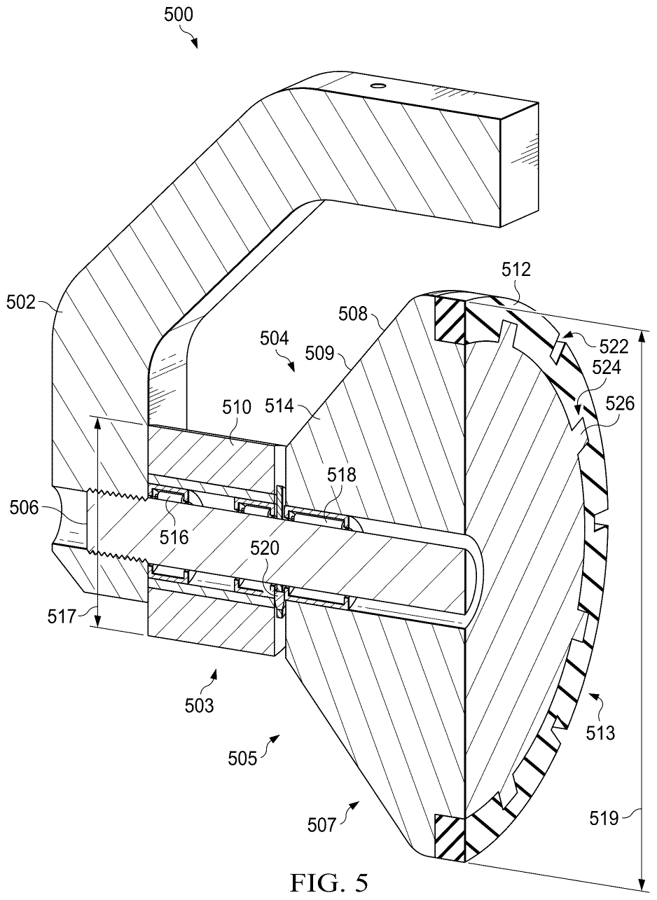

Turning now to FIG. 5, an illustration of a cross-sectional view of a compactor is depicted in accordance with an illustrative embodiment. Compactor 504 can be used to compact a composite material in manufacturing a component of aircraft 100 of FIG. 1. Compactor 504 is a physical implementation of compactor 204 of FIGS. 2A and 2B. Compactor 504 is a physical implementation of compactor 304 of FIGS. 3A and 3B.

In view 500, compactor 504 is connected to end effector 502. In this illustrative example, compactor 504 comprises roller compactor 505. Roller compactor 505 comprises independently movable roller segments 503.

In this illustrative example, roller compactor 505 configured to compact a composite material comprises rotational shaft 506, roller body 508 rotatably seated on rotational shaft 506, and auxiliary roller 510 rotatably seated on rotational shaft 506 such that auxiliary roller 510 is independently movable relative to roller body 508. In this illustrative example, by having independently movable roller segments 503, roller compactor 505 can have different angular velocities for auxiliary roller 510 and roller body 508 while maintaining a single velocity for roller compactor 505 over a composite member. In some illustrative examples, roller compactor 505 provides for compaction of a composite member with reduced inconsistencies including reduced wrinkling.

In this illustrative example, roller compactor 505 comprises first portion 509 of compaction surface 507 formed of first material 514, and second portion 513 of compaction surface 507 formed of second material 512 having a lower hardness than first material 514. Second portion 513 is configured to selectively reduce compaction pressure by second portion 513 of compaction surface 507. In some illustrative examples, first material 514 is referred to as a rigid material. In some illustrative examples, second material 512 is referred to as a compliant material.

In some illustrative examples, roller compactor 505 further comprises adhesive (not depicted) between first material 514 and second material 512. In some illustrative examples, second material 512 is restrained against first material 514 by friction.

In some illustrative examples, roller compactor 505 further comprises protrusions 526 formed of first material 514, and channels 524 in second material 512 positioned over protrusions 526 to secure second material 512 to first material 514. Protrusions 526 and channels 524 may be referred to as mechanical connectors.

Although protrusions 526 are shown as being formed of first material 514, in other illustrative examples, second material 512 forms protrusions while first material 514 has channels. In some illustrative examples, first material 514 and second material 512 each have a mixture of protrusions and channels to restrain second material 512 on first material 514.

In this illustrative example, roller compactor 505 comprises roller body 508 comprising a trapezoidal cross-section including web forming surfaces and a cap forming surface. In other illustrative examples, roller compactor 505 has any desirable cross-section configured to provide compaction to an elongate composite member. Additionally, roller compactor 505 comprises any desirable quantity of independently movable roller segments.

In this illustrative example, roller compactor 505 further comprises roller bearings 518 between roller body 508 and rotational shaft 506. In this illustrative example, roller compactor 505 further comprises bearings 520 between roller body 508 and auxiliary roller 510.

In this illustrative example, auxiliary roller 510 is cylindrical. However, auxiliary roller 510 can have any desirable cross-sectional shape. Auxiliary roller 510 can have any desirable size and any desirable cross-sectional shape to form portions of a cross-sectional shape of an elongate composite member.

In this illustrative example, roller body 508 comprises a trapezoidal cross-section. However, roller body 508 has any desirable cross-sectional shape. Roller body 508 can have any desirable size and any desirable cross-sectional shape to form portions of a cross-sectional shape of an elongate composite member.

In this illustrative example, roller compactor 505 is configured to compact a composite material and comprises roller body 508 having first diameter 519, and auxiliary roller 510 adjacent roller body 508. Auxiliary roller 510 has second diameter 517 smaller than roller body 508 and independently movable relative to roller body 508 such that auxiliary roller 510 can have a different angular velocity than roller body 508. In this illustrative example, roller compactor 505 further comprises bearings 516 between auxiliary roller 510 and rotational shaft 506.

In this illustrative example, roller compactor 505 comprises compaction surface 507 configured to contact a composite material, and channels 522 extending across at least a portion of compaction surface 507. In this illustrative example, channels 522 extending through second material 512 are visible. However, additional channels (not visible) can be present in roller compactor 505.

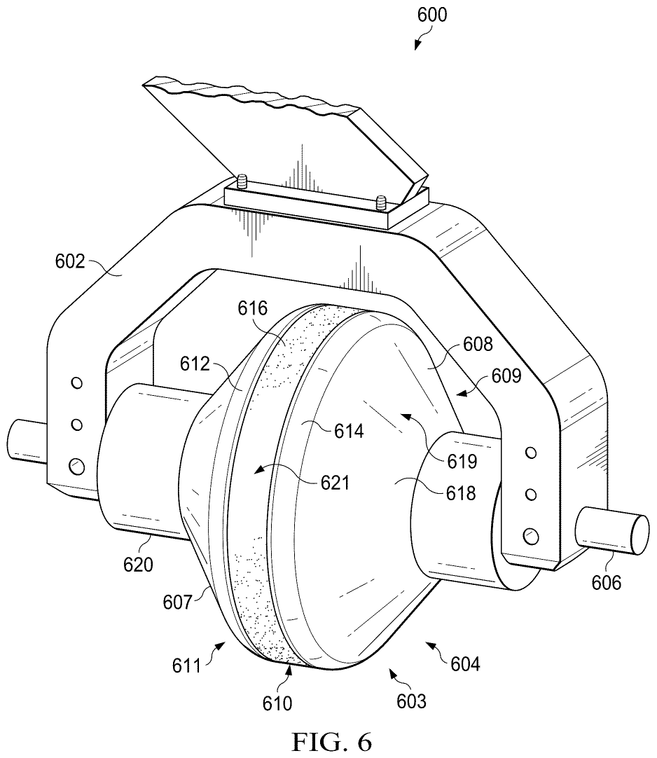

Turning now to FIG. 6, an illustration of an isometric view of a compactor is depicted in accordance with an illustrative embodiment. Compactor 604 can be used to compact a composite material in manufacturing a component of aircraft 100 of FIG. 1. Compactor 604 is a physical implementation of compactor 204 of FIGS. 2A and 2B. Compactor 604 is a physical implementation of compactor 304 of FIGS. 3A and 3B.

In view 600, end effector 602 comprises compactor 604. In this illustrative example, compactor 604 is roller compactor 609.

Compactor 604 comprises compaction surface 607 formed of two different materials. Compactor 604 comprises compaction surface 607 formed of first material 618 and second material 616 having a lower hardness than first material 618.

The multi-material design of compactor 604 provides variable compaction pressure to be locally intensified/relaxed in different regions. By varying the compliance of the material of compaction surface 607, compaction of the composite material is improved. The compliance of compaction surface 607 can be locally increased or decreased relative to other portions of compaction surface 607 to locally control compaction and friction. In some illustrative examples, for composite stiffeners such as stringers, additional compaction at radiuses connecting the webs and the cap can improve compaction. In some illustrative examples for composite stiffeners such as stringers, less compaction can be applied at locations outside of the radiuses to tailor stringer quality and prevent out of tolerance inconsistencies. In some illustrative examples, additional compaction at radiuses connecting the webs and the cap can enable compaction of material in the female radius of the stringer hat without bridging. In some illustrative examples, additional compaction can be applied at other locations of composite stiffeners.

Compactor 604 is configured to compact a composite material to a forming tool. In this illustrative example, compactor 604 comprises web forming surfaces 608 of roller body 603 formed of first material 618, and cap forming surface 610 of roller body 603 formed of a second material 616 having a lower hardness than the first material. In some illustrative examples, web forming surfaces 608 are referred to as angled walls. In some illustrative examples, cap forming surface 610 is referred to as a planar surface.

Roller body 603 is rotatably mounted to rotational shaft 606. Roller body 603 will apply pressure to a composite material to compact the composite material as roller body 603 rotates about rotational shaft 606.

In this illustrative example, radiuses are present between web forming surfaces 608 and cap forming surface 610. In this illustrative example, the radiuses include radius 612 and radius 614, wherein the radiuses are formed of first material 618. By radius 612 and radius 614 being formed of first material 618 with a greater hardness than second material 616, radius 612 and radius 614 can apply additional compaction to composite material over female radiuses in a forming tool.

In this illustrative example, compactor 604 further comprises flange forming surfaces 620. In this illustrative example, flange forming surfaces 620 are formed of first material 618. However, in other illustrative examples, flange forming surfaces 620 can be formed of any desired material based on a desired level of compaction.

In this illustrative example, although two materials with different durometer hardnesses are depicted, in other illustrative examples, more than two materials can be used. In some illustrative examples, compactor 604 can comprise more than two materials with different durometer hardnesses. In some illustrative examples, the material of compaction surface 607 can be tailored based on desired compaction and a cross-sectional shape of a composite material to be compacted. In some illustrative examples, first material 618 has a range of hardnesses. In some illustrative examples, second material 616 has a different range of hardnesses.

Although first material 618 and second material 616 have different hardnesses, in some illustrative examples, first material 618 and second material 616 are a same material. In some illustrative examples, first material 618 and second material 616 are a same base material with different additives to control hardnesses. In some illustrative examples, first material 618 and second material 616 are a same base material with different processing to control hardnesses. In some illustrative examples, first material 618 and second material 616 are different materials.

Second material 616 can be joined to first material 618 by any desirable method. In some illustrative examples, roller body 603 is three-dimensionally printed. In some illustrative examples, first material 618 and second material 616 are three-dimensionally printed together. In some illustrative examples, second material 616 can be joined to first material 618 by an adhesive between first material 618 and second material 616. In some illustrative examples, second material 616 is restrained against first material 618 by friction. In some illustrative examples, mechanical connectors maintain second material 616 on first material 618. In some illustrative examples, mechanical connectors comprise protrusions formed of first material 618 and channels in second material 616 positioned over the protrusions to secure second material 616 to first material 618. In some illustrative examples, mechanical connectors comprise protrusions formed of second material 616 and channels in first material 618 receiving the protrusions to secure second material 616 to first material 618.

In this illustrative example, compactor 604 is configured to compact an elongate composite member having a hat-shaped cross-section. In this illustrative example, roller body 603 of compactor 604 comprises trapezoidal cross-section 611 including web forming surfaces 608 and cap forming surface 610.

In some illustrative examples, roller compactor 609 comprises first portion 619 of compaction surface 607 formed of first material 618, and second portion 621 of compaction surface 607 formed of second material 616 having a lower hardness than first material 618. Second portion 621 is configured to selectively reduce compaction pressure by second portion 621 of compaction surface 607.

Compaction surface 607 is configured to contact a composite material during compaction. In some illustrative examples, compaction surface 607 is complementary to a cross-sectional shape of a composite member. In some illustrative examples, compaction surface 607 is complementary to a forming surface of a forming tool.

Second portion 621 is selected to reduce compaction inconsistencies in a composite material compacted by rolling roller compactor 609 over the composite material. In some illustrative examples, at least one of second material 616 or second portion 621 are selected to reduce compaction inconsistencies such as wrinkles, gaps, or bridging.

In this illustrative example, first portion 619 of compaction surface 607 comprises web forming surfaces 608, and wherein the second portion 621 of compaction surface 607 comprises cap forming surface 610. In some illustrative examples, a size and a shape of cap forming surface 610 are configured to reduce bridging in a composite member, such as an elongate composite member.

In some illustrative examples, bridging can be reduced by providing a more compliant surface for cap forming surface 610. In this illustrative example, radiuses are present between web forming surfaces 608 and cap forming surface 610, wherein the radiuses are formed of first material 618.

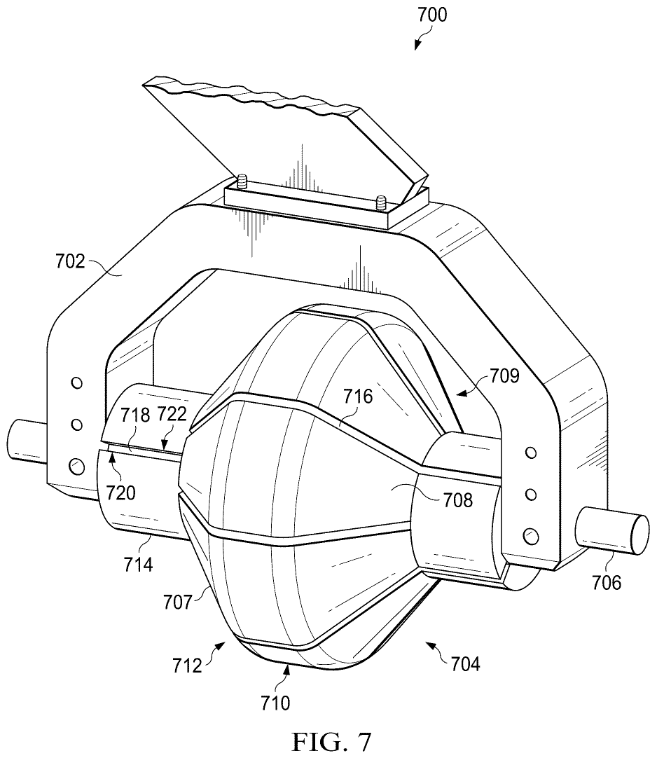

Turning now to FIG. 7, an illustration of an isometric view of a compactor is depicted in accordance with an illustrative embodiment. Compactor 704 can be used to compact a composite material in manufacturing a component of aircraft 100 of FIG. 1. Compactor 704 is a physical implementation of compactor 204 of FIGS. 2A and 2B. Compactor 704 is a physical implementation of compactor 304 of FIGS. 3A and 3B.

In view 700, end effector 702 comprises compactor 704. In this illustrative example, compactor 704 is roller compactor 709. Roller compactor 709 is rotatably mounted to rotational shaft 706.

Roller compactor 709 comprises channels 716 and channels 718. In some illustrative examples, at least one channel of channels 716 or channels 718 is filled or partially filled with compliant material, such as silicone. Channels 716 and channels 718 are positioned on roller compactor 709 to provide compaction relief.

Channels 716 and channels 718 facilitate composite forming. Channels 716 and channels 718 facilitate composite forming with forming relief facilitated by channels 716 and channels 718. In some illustrative examples, channels 716 and channels 718 facilitate within tolerance difference zones corresponding to channels 716 and channels 718 rather than out of tolerance wrinkles.

In some illustrative examples, the within tolerance differences can be reduced through autoclave and curing processing. Variables for channels 716 and channels 718 include frequency, width, and path. In some illustrative examples, channels 718 are positioned every 45 degrees of the 360 degrees of a cross-section. In some illustrative examples, the width of channels 718 is in a range of 0.1″ to 0.2″.

Roller compactor 709 comprises compaction surface 707 configured to contact a composite material, and channels 716 extending across at least a portion of compaction surface 707.

In this illustrative example, channels 716 extend continuously across web forming surfaces 708 and cap forming surface 710. In this illustrative example, channels 716 are discontinuous on compaction surface 707. Channels 716 are linear across compaction surface 707. In other non-depicted examples, channels 716 can be curved or have any desirable path across compaction surface 707. In this illustrative example, channels 716 have a frequency of approximately every 45 degrees around roller body 712.

In this illustrative example, channels 718 extend continuously across flange forming surfaces 714. In this illustrative example, channels 718 are discontinuous 720 on compaction surface 707. Channels 718 are linear across compaction surface 707. In other non-depicted examples, channels 718 can be curved or have any desirable path across compaction surface 707. In this illustrative example, channels 718 have a frequency of approximately every 90 degrees around portion of roller compactor 709 having flange forming surfaces 714.

In some illustrative examples, a depth of a channel is the same throughout the channel. In some illustrative examples, a depth of a channel varies along the channel. In some illustrative examples, depths of some channels are different than depths of other channels. In some illustrative examples, depths of channels 718 are configured to provide a desired compaction relief. In some illustrative examples, depths of channels 718 vary across compaction surface 707.

In some illustrative examples, a width of a channel is the same throughout the channel. In some illustrative examples, a width of a channel, such as a channel of channels 718 or channels 716, varies along the channel. In some illustrative examples, widths of some channels, such as a channel of channels 718 or channels 716, are different than widths of other channels. In some illustrative examples, widths of channels 718 are configured to provide a desired compaction relief. In some illustrative examples, widths of channels 718 vary across compaction surface 707.

As depicted, both channels 718 and channels 716 are substantially straight 722. In other non-depicted examples, channels across compaction surface 707 can have an alternative path, such as a curved path.

As depicted, compaction surface 707 comprises cap forming surface 710, web forming surfaces 708 opposite cap forming surface 710, and flange forming surfaces 714 adjacent web forming surfaces 708 and wherein channels 718 extending across at least a portion of flange forming surfaces 714 have at least one of a different width, a different frequency, or a different depth than channels 716 of web forming surfaces 708.

In this illustrative example, more than one set of channels is present. In this illustrative example, each set of channels, channels 716 and channels 718, has a respective shape. In this illustrative example, a path for channels 716 is different for a path for channels 718. In some illustrative examples, channels 716 have a same width and depth as channels 718. In other illustrative examples, width and depth of channels 716 can be different from channels 718.

In some illustrative examples, a filler material (not depicted) is present within at least one channel of channels 718. In these illustrative examples, the filler material has a lower hardness than a first material of the compaction surface.

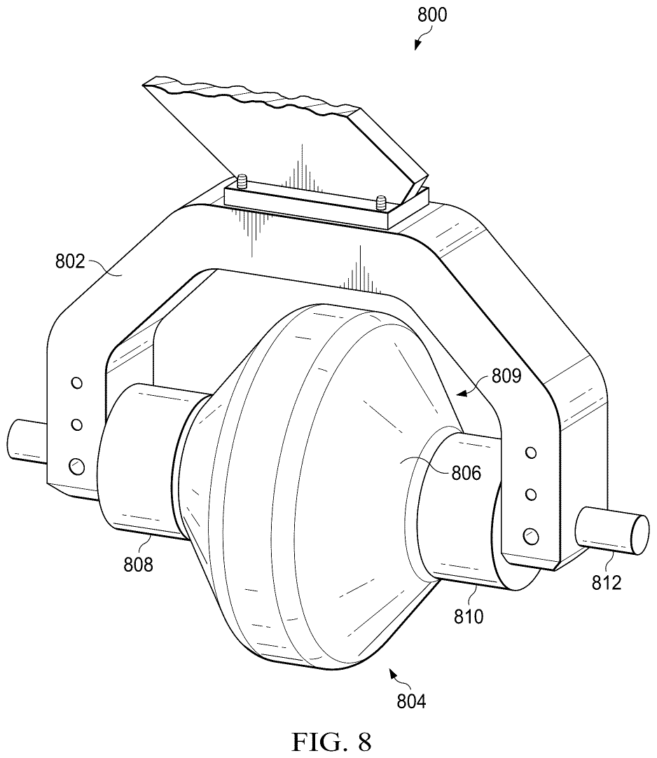

Turning now to FIG. 8, an illustration of an isometric view of a compactor is depicted in accordance with an illustrative embodiment. Compactor 804 can be used to compact a composite material in manufacturing a component of aircraft 100 of FIG. 1. Compactor 804 is a physical implementation of compactor 204 of FIGS. 2A and 2B. Compactor 804 is a physical implementation of compactor 304 of FIGS. 3A and 3B.

In view 800, end effector 802 comprises compactor 804. In this illustrative example, compactor 804 is a roller compactor 809. Roller compactor 809 comprises rotational shaft 812. Roller body 806 of roller compactor 809 is rotatably mounted to rotational shaft 812.

Roller compactor 809 is designed to maintain constant rotation speed at a point of contact with a composite material being compacted. Roller compactor 809 is designed to compact the composite material without undesirable levels of friction. Segmentation of roller compactor 809 to form independently movable roller segments enables larger diameter roller segments to rotate more slowly than smaller diameter roller segments. In this illustrative example, the center of roller body 806 rotates slower than smaller diameter sections, such as auxiliary roller 808. An equation that can be used to estimate the rotation for a roller segment is V=AV*Radius (V is velocity at forming surface, AV is angular Velocity and R is radius). Velocity will be the same for all different diameters/radii.

Roller compactor 809 is passively powered through friction connection between the compaction surface and a composite material being compacted. Each independently movable roller segment has an independent stimulation during rolling. Each independently movable roller segment can have a different stimulation depending upon a design of each independently movable roller segment and direction of steering. For example, steering to the right causes a right flange roller, such as auxiliary roller 810, to travel less distance than a left flange roller, such as auxiliary roller 808. Bearings between the independently movable roller segments allow independent rotation of each roller segment.

In this illustrative example, roller compactor 809 is configured to compact a composite material and roller compactor 809 comprises rotational shaft 812, roller body 806 rotatably seated on rotational shaft 812, and auxiliary roller 808 rotatably seated on rotational shaft 812 such that auxiliary roller 808 is independently movable relative to roller body 806. In this illustrative example, roller compactor 809 further comprises auxiliary roller 810 rotatably seated on rotational shaft 812 such that auxiliary roller 810 is independently movable relative to roller body 806.

Roller bearings (not depicted) are present between roller body 806 and rotational shaft 812. Roller bearings (not depicted) between roller body 806 and rotational shaft 812 enable rotation of roller body 806 around rotational shaft 812.

Roller bearings (not depicted) are present between auxiliary roller 808 and rotational shaft 812.

Roller bearings (not depicted) between auxiliary roller 808 and rotational shaft 812 enable rotation of auxiliary roller 808 around rotational shaft 812.

Roller bearings (not depicted) are present between auxiliary roller 810 and rotational shaft 812. Roller bearings (not depicted) between auxiliary roller 810 and rotational shaft 812 enable rotation of auxiliary roller 810 around rotational shaft 812.

In some illustrative examples, roller compactor 809 further comprises bearings (not depicted) between roller body 806 and auxiliary roller 808. In some illustrative examples, roller compactor 809 further comprises bearings (not depicted) between roller body 806 and auxiliary roller 810.

In this illustrative example, roller body 806 has a first diameter and auxiliary roller 808 has a second diameter different from the first diameter. In this illustrative example, the first diameter is larger than the second diameter.

In this illustrative example, roller body 806 has a first diameter and auxiliary roller 810 has a third diameter different from the first diameter. In this illustrative example, the first diameter is larger than the third diameter.

Roller body 806 and auxiliary roller 808 are configured to have a same velocity at a forming surface and different angular velocities while maintaining compaction with desirable levels of friction. Roller body 806 and auxiliary roller 810 are configured to have a same velocity at a forming surface and different angular velocities while maintaining compaction with desirable levels of friction.

In this illustrative example, auxiliary roller 808 is cylindrical. In this illustrative example, auxiliary roller 810 is cylindrical. In this illustrative example, roller body 806 comprises a trapezoidal cross-section. In this illustrative example, roller body 806 comprises web forming surfaces and a cap forming surface. In this illustrative example, auxiliary roller 808 comprises a flange forming surface. In this illustrative example, auxiliary roller 810 comprises a flange forming surface.

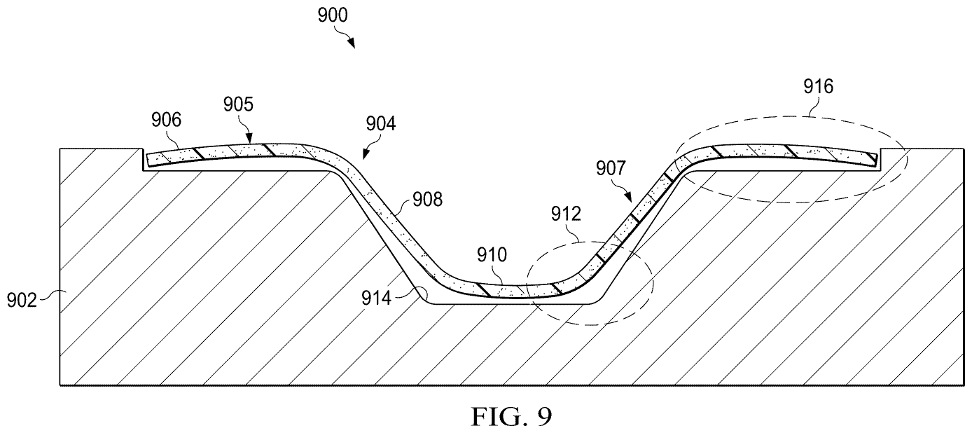

Turning now to FIG. 9, an illustration of a cross-sectional view of an elongate composite member that can be compacted by a compactor is depicted in accordance with an illustrative embodiment. In view 900, composite material 904 is shown on a forming surface of forming tool 902. In this illustrative example, composite material 904 has not yet been compacted.

In some illustrative examples, composite material 904 can be compacted onto forming tool 902 to manufacture a component of aircraft 100 of FIG. 1. In some illustrative examples, composite material 904 can be an implementation of composite material 254 that can be compacted by compactor 204 of FIGS. 2A and 2B. In some illustrative examples, composite material 904 can be an implementation of composite material 347 that can be compacted by compactor 304 of FIGS. 3A and 3B. In some illustrative examples, composite material 904 can be compacted onto forming tool 902 by compactor 404 of FIG. 4. In some illustrative examples, composite material 904 can be compacted onto forming tool 902 by compactor 504 of FIG. 5. In some illustrative examples, composite material 904 can be compacted onto forming tool 902 by compactor 604 of FIG. 6. In some illustrative examples, composite material 904 can be compacted onto forming tool 902 by compactor 704 of FIG. 7. In some illustrative examples, composite material 904 can be compacted onto forming tool 902 by compactor 804 of FIG. 8.

In view 900, composite material 904 is present on forming tool 902. In this illustrative example, forming tool 902 comprises a cavity to receive and form composite material 904 against an inner mold line.

Elongate composite member 905 has trapezoidal cross-sectional shape 907. In this illustrative example, elongate composite member 905 has flanges 906, webs 908, and cap 910. In this illustrative example, composite material 904 of elongate composite member 905 is not fully in contact with forming tool 902. In this illustrative example, gaps 916 are present in region of flanges 906. In this illustrative example, bridging 912 is present in radiuses 914 of forming tool 902.

Compaction pressure for compaction of composite material 904 can be tailored to apply desired levels of compaction into radiuses 914 to reduce or eliminate bridging 912. Compaction pressure for compaction of composite material 904 can be tailored to apply desired levels of compaction to flanges 906 to reduce or eliminate gaps 916. The roller compactors of the illustrative examples can be used to reduce or eliminate at least one of bridging 912 or gaps 916. The roller compactors of the illustrative examples can compact composite material 904 against forming tool 902 while not introducing further inconsistencies. The roller compactors of the illustrative examples can compact composite material 904 against forming tool 902 with minimal or no introduction of wrinkles.

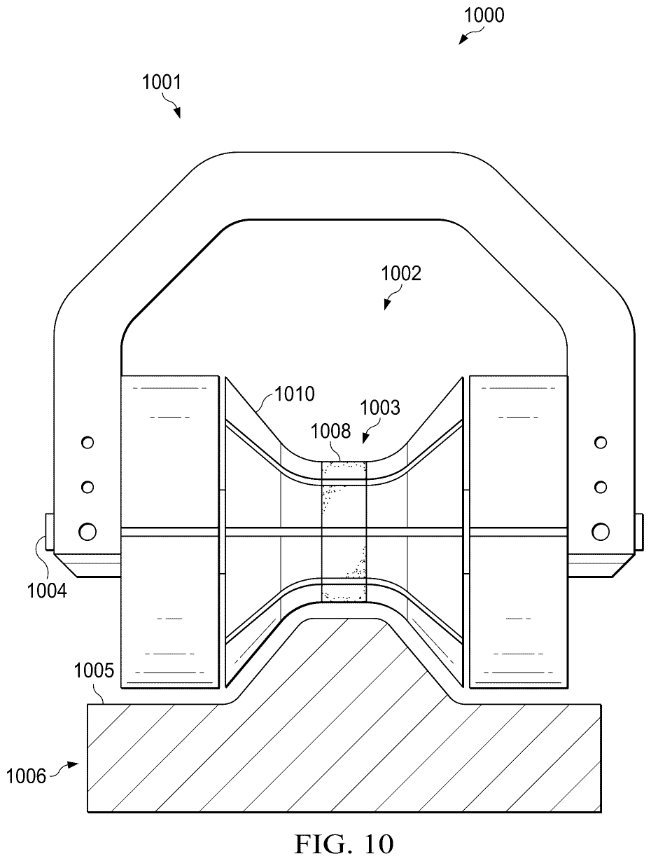

Turning now to FIG. 10, an illustration of a simplified side view of a compactor is depicted in accordance with an illustrative embodiment. Compactor 1002 can be used to compact a composite material in manufacturing a component of aircraft 100 of FIG. 1. Compactor 1002 is a physical implementation of compactor 204 of FIGS. 2A and 2B. Compactor 1002 is a physical implementation of compactor 304 of FIGS. 3A and 3B.

In view 1000, end effector 1001 comprises compactor 1002. In this illustrative example, compactor 1002 is a roller compactor. Compactor 1002 comprises rotational shaft 1004. Compactor 1002 comprises cross-sectional shape 1003 configured to complement forming surface 1005 of forming tool 1006. In this illustrative example, cross-sectional shape 1003 is formed by first portion 1008 having a smaller diameter than second portion 1010 of compactor 1002. In this illustrative example, the center of compactor 1002 has a smaller diameter than the outer portions of compactor 1002.

Compactor 1002 comprises an desirable design choices for improving compaction quality for a composite material. In this illustrative example, first portion 1008 is formed of a first material while second portion 1010 is formed of a second material. In some illustrative examples, channels are present in compactor 1002. In some illustrative examples, compactor 1002 comprises a plurality of independently movable roller segments.

In this illustrative example, compactor 1002 is configured to compact a composite member on a convex portion of forming surface 1005. However, a compactor of the illustrative examples can have any desirable cross-sectional shape configured to complement a forming surface of a respective forming tool. A roller compactor can comprise any desirable cross-section configured to compact a cross-sectional shape of a composite member.

In some illustrative examples, a compactor can have any desirable combination of at least one of angled portions, planar portions, or curved portions. In some illustrative examples, a compactor can have any desirable quantity of roller segments. In some illustrative examples, a compactor comprises any desirable materials.

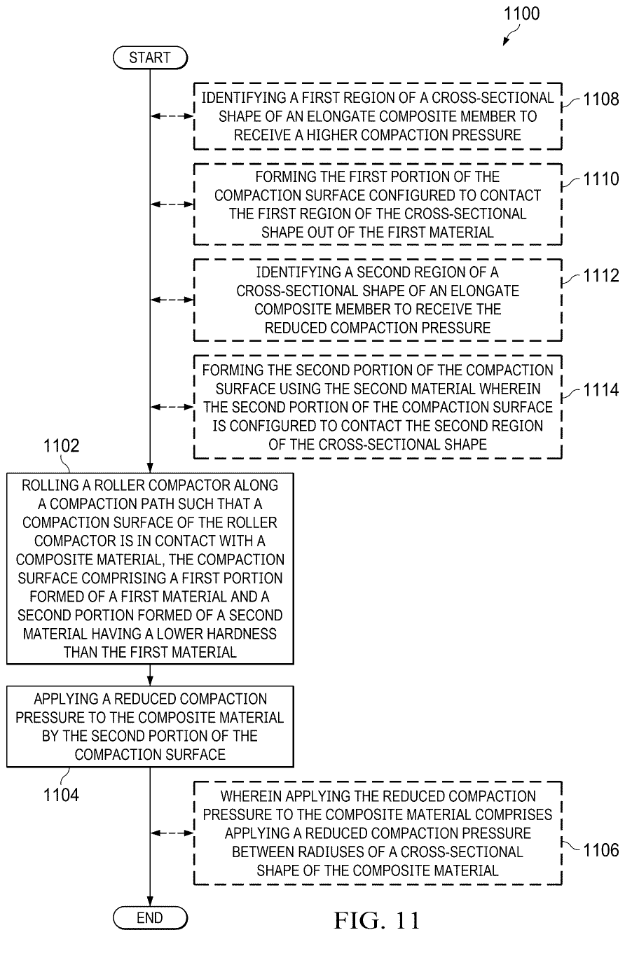

Turning now to FIG. 11, a flowchart of a method of compacting a composite material is depicted in accordance with an illustrative embodiment. Method 1100 can be performed to form a composite stiffener of aircraft 100 FIG. 1. Method 1100 can be performed using roller compactor 206 of FIGS. 2A and 2B. Method 1100 can be performed using roller compactor 306 of FIGS. 3A and 3B. Method 1100 can be performed using compactor 404 of FIG. 4. Method 1100 can be performed using compactor 504 of FIG. 5. Method 1100 can be performed using compactor 604 of FIG. 6. Method 1100 can be performed to compact composite material 904 of FIG. 9. Method 1100 can be performed using compactor 1002 of FIG. 10.

Method 1100 rolls a roller compactor along a compaction path such that a compaction surface of the roller compactor is in contact with a composite material, the compaction surface comprising a first portion formed of a first material and a second portion formed of a second material having a lower hardness than the first material (operation 1102). Method 1100 applies a reduced compaction pressure to the composite material by the second portion of the compaction surface (operation 1104). Afterwards, method 1100 terminates.

In some illustrative examples, applying the reduced compaction pressure to the composite material comprises applying a reduced compaction pressure between radiuses of a cross-sectional shape of the composite material (operation 1106). In some illustrative examples, by applying reduced compaction pressure between the radiuses, the composite material in the radiuses is compacted sufficiently with reduced or eliminated inconsistencies such as bridging. In some illustrative examples, by applying reduced compaction pressure between the radiuses, the composite material in the radiuses receives sufficient compaction pressure for pushing composite material into the radiuses.

In some illustrative examples, method 1100 identifies a first region of a cross-sectional shape of an elongate composite member to receive a higher compaction pressure (operation 1108). In some illustrative examples, method 1100 forms the first portion of the compaction surface configured to contact the first region of the cross-sectional shape out of the first material (operation 1110).

In some illustrative examples, method 1100 identifies a second region of a cross-sectional shape of an elongate composite member to receive the reduced compaction pressure (operation 1112). In some illustrative examples, method 1100 forms the second portion of the compaction surface using the second material wherein the second portion of the compaction surface is configured to contact the second region of the cross-sectional shape (operation 1114). In some illustrative examples, the second material is referred to as a compliant material. In some illustrative examples, the compliant material is a second portion of the compaction surface configured to apply a lower compaction force to the second region. In these illustrative examples, a first portion has a greater compaction force to sufficiently compact a portion of the composite material.

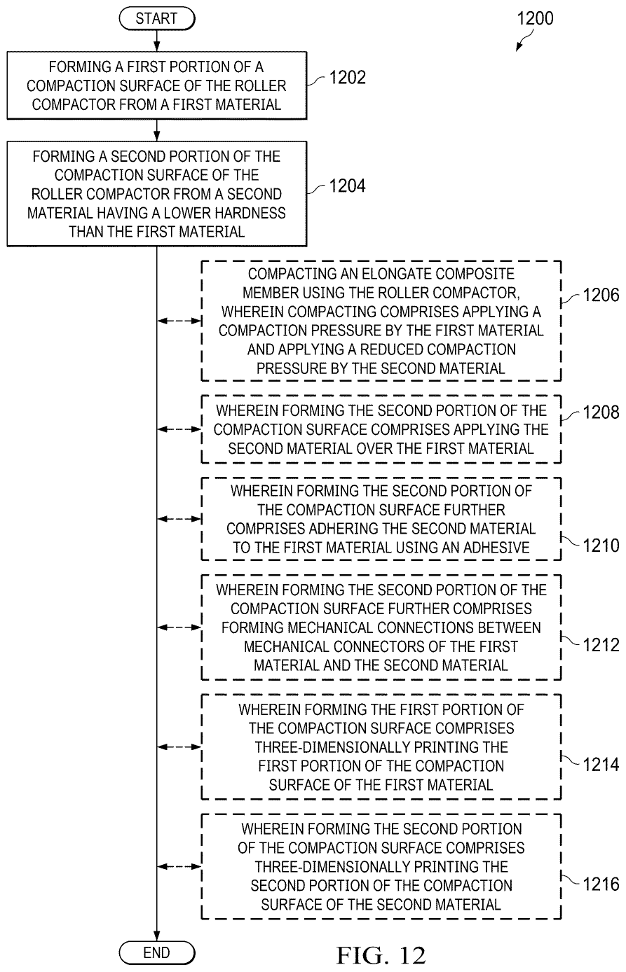

Turning now to FIG. 12, a flowchart of a method of controlling compaction pressure of a roller compactor is depicted in accordance with an illustrative embodiment. Method 1200 can be performed to form a roller compactor for compacting a composite stiffener of aircraft 100 of FIG. 1. Method 1200 can be performed to form roller compactor 206 of FIGS. 2A and 2B. Method 1200 can be performed to form roller compactor 306 of FIGS. 3A and 3B. Method 1200 can be performed to form compactor 404 of FIG. 4. Method 1200 can be performed to form compactor 504 of FIG. 5. Method 1200 can be performed to form compactor 604 of FIG. 6. Method 1200 can be performed to form a roller compactor to compact composite material 904 of FIG. 9. Method 1200 can be performed using compactor 1002 of FIG. 10.

Method 1200 forms a first portion of a compaction surface of the roller compactor from a first material (operation 1202). Method 1200 forms a second portion of the compaction surface of the roller compactor from a second material having a lower hardness than the first material (operation 1204). Afterwards, method 1200 terminates.

In some illustrative examples, method 1200 compacts an elongate composite member using the roller compactor, wherein compacting comprises applying a compaction pressure by the first material and applying a reduced compaction pressure by the second material (operation 1206). In some illustrative examples, the second material applies reduced compaction pressure in comparison to the first material based on the increased compliance of the second material in comparison to the first material.

In some illustrative examples, forming the second portion of the compaction surface comprises applying the second material over the first material (operation 1208). In some illustrative examples, friction between the first material and the second material maintains the second material on the first material. In some illustrative examples, forming the second portion of the compaction surface further comprises adhering the second material to the first material using an adhesive (operation 1210).

In some illustrative examples, forming the second portion of the compaction surface further comprises forming mechanical connections between mechanical connectors of the first material and the second material (operation 1212). In some illustrative examples, the mechanical connectors comprise protrusions and internal channels.

In some illustrative examples, forming the first portion of the compaction surface comprises three-dimensionally printing the first portion of the compaction surface of the first material (operation 1214), and wherein forming the second portion of the compaction surface comprises three-dimensionally printing the second portion of the compaction surface of the second material (operation 1216). In some illustrative examples, the second material is three-dimensionally printed separately from the first material. In some illustrative examples, the second material can be adhered to the first material after three-dimensionally printing the second portion.

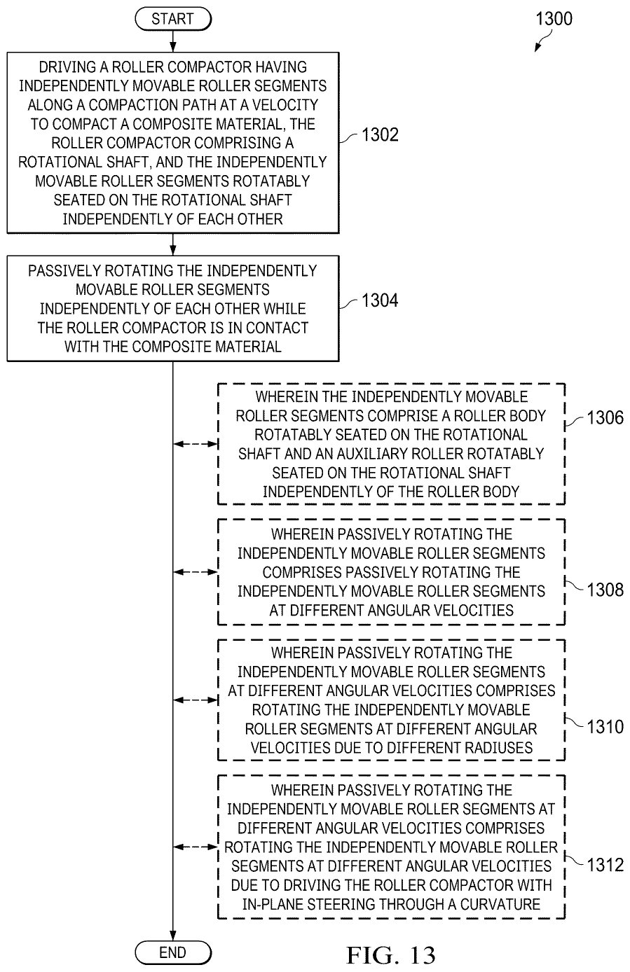

Turning now to FIG. 13, a flowchart of a method of compacting a composite material is depicted in accordance with an illustrative embodiment. Method 1300 can be performed to form a roller compactor for compacting a composite stiffener of aircraft 100 of FIG. 1. Method 1300 can be performed to form roller compactor 206 of FIGS. 2A and 2B. Method 1300 can be performed to form roller compactor 306 of FIGS. 3A and 3B. Method 1300 can be performed to form compactor 404 of FIG. 4. Method 1300 can be performed to form compactor 504 of FIG. 5. Method 1300 can be performed to form compactor 804 of FIG. 8. Method 1300 can be performed to form a roller compactor to compact composite material 904 of FIG. 9.

Method 1300 drives a roller compactor having independently movable roller segments along a compaction path at a velocity to compact a composite material, the roller compactor comprising a rotational shaft, and the independently movable roller segments rotatably seated on the rotational shaft independently of each other (operation 1302). Method 1300 passively rotates the independently movable roller segments independently of each other while the roller compactor is in contact with the composite material (operation 1304). Afterwards, method 1300 terminates.

In some illustrative examples, the independently movable roller segments comprise a roller body rotatably seated on the rotational shaft and an auxiliary roller rotatably seated on the rotational shaft independently of the roller body (operation 1306). In some illustrative examples, the independently movable roller segments further comprise a second auxiliary roller, wherein the roller body is positioned between the auxiliary rollers. In some illustrative examples, the auxiliary rollers comprise flange forming surfaces.

In some illustrative examples, passively rotating the independently movable roller segments comprises passively rotating the independently movable roller segments at different angular velocities (operation 1308). In some illustrative examples, passively rotating the independently movable roller segments at different angular velocities comprises rotating the independently movable roller segments at different angular velocities due to different radiuses (operation 1310). In some illustrative examples, roller segments with smaller radiuses have higher angular velocities.

In some illustrative examples, passively rotating the independently movable roller segments at different angular velocities comprises rotating the independently movable roller segments at different angular velocities due to driving the roller compactor with in-plane steering through a curvature (operation 1312). In some illustrative examples, roller segments of the independently movable roller segments in the direction of the curvature have a lower angular velocity.

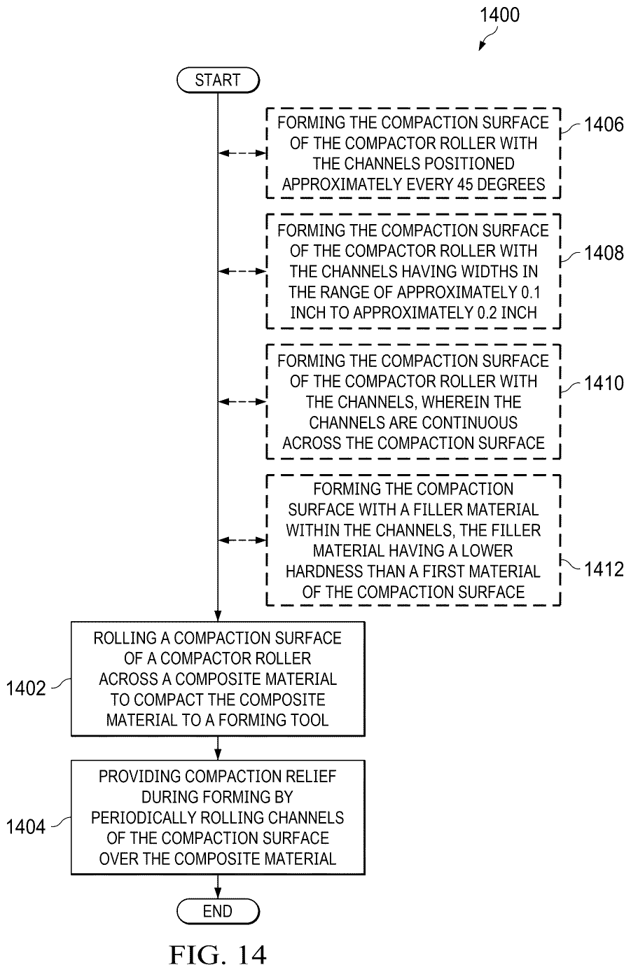

Turning now to FIG. 14, a flowchart of a method of compacting a composite material is depicted in accordance with an illustrative embodiment. Method 1400 can be performed to form a roller compactor for compacting a composite stiffener of aircraft 100 of FIG. 1. Method 1400 can be performed to form roller compactor 206 of FIGS. 2A and 2B. Method 1400 can be performed to form roller compactor 306 of FIGS. 3A and 3B. Method 1400 can be performed to form compactor 404 of FIG. 4. Method 1400 can be performed to form compactor 504 of FIG. 5. Method 1400 can be performed to form compactor 704 of FIG. 7. Method 1400 can be performed to form a roller compactor to compact composite material 904 of FIG. 9.

Method 1400 rolls a compaction surface of a roller compactor across a composite material to compact the composite material to a forming tool (operation 1402). Method 1400 provides compaction relief during forming by periodically rolling channels of the compaction surface over the composite material (operation 1404). Afterwards, method 1400 terminates.

In some illustrative examples, method 1400 forms the compaction surface of the roller compactor with the channels positioned approximately every 45 degrees (operation 1406). In some illustrative examples, the channels are positioned approximately every 90 degrees. In some illustrative examples, the frequency of channels is configured to provide desired relief for the composite material.

In some illustrative examples, method 1400 forms the compaction surface of the roller compactor with the channels having widths in the range of approximately 0.1 inch to approximately 0.2 inch (operation 1408). In some illustrative examples, each channel has a substantially constant width. In some illustrative examples, at least one channel has a variable width. In some illustrative examples, each channel has the same width. In some illustrative examples, channels of different widths are present in the compaction surface.

In some illustrative examples, method 1400 forms the compaction surface of the roller compactor with the channels, wherein the channels are continuous across the compaction surface (operation 1410). In some illustrative examples, the channels extend continuously across the compaction surface in a direction parallel to a rotational axis of the compaction surface. In some illustrative examples, the channels extend continuously across the compaction surface from a first edge to a second edge. In other illustrative examples, at least one channel is discontinuous on the compaction surface. In other illustrative examples, at least one channel extends partially from one edge into the compaction surface and terminates prior to reaching an opposite edge of the compaction surface.

In some illustrative examples, method 1400 forms the compaction surface with a filler material within the channels, the filler material having a lower hardness than a first material of the compaction surface (operation 1412). In some illustrative examples, the filler material completely fills the channels. In some illustrative examples, filler material only partially fills the channels. In some illustrative examples, the filler material is a polymeric material. In some illustrative examples, the filler material is silicone.

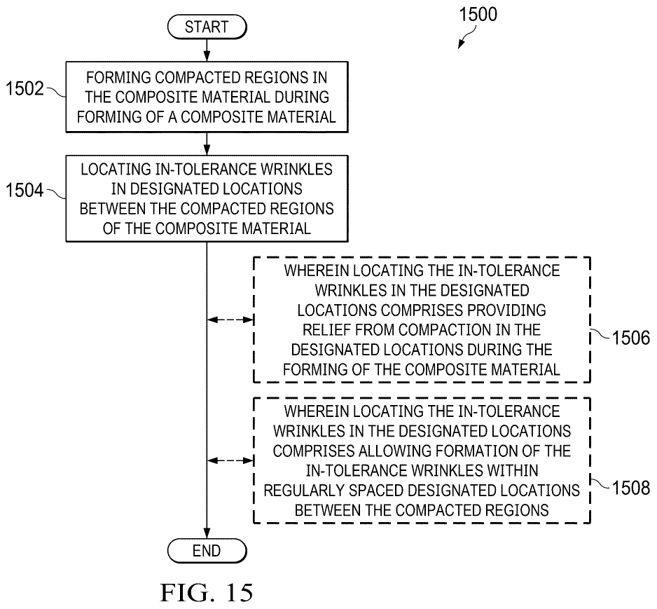

Turning now to FIG. 15, a flowchart of a method of selectively forming wrinkles in a composite material during forming is depicted in accordance with an illustrative embodiment. Method 1500 can be performed to compact a composite structure of aircraft 100 of FIG. 1. Method 1500 can be performed to compact composite material 254 of FIGS. 2A and 2B. Method 1500 can be performed to compact composite material 347 of FIGS. 3A and 3B. In some illustrative examples, method 1500 can be performed using compactor 404 of FIG. 4. Method 1500 can be performed using compactor 504 of FIG. 5. Method 1500 can be performed using compactor 704 of FIG. 7. Method 1500 can be performed to compact composite material 904 of FIG. 9. Method 1500 can be performed using compactor 1002 of FIG. 10.

Method 1500 forms compacted regions in the composite material during forming of a composite material (operation 1502). Method 1500 locates in-tolerance wrinkles in designated locations between the compacted regions of the composite material (operation 1504). Afterwards, method 1500 terminates.

In some illustrative examples, locating the in-tolerance wrinkles in the designated locations comprises providing relief from compaction in the designated locations during the forming of the composite material (operation 1506). In some illustrative examples, locating the in-tolerance wrinkles in the designated locations comprises allowing formation of the in-tolerance wrinkles within regularly spaced designated locations between the compacted regions (operation 1508).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional.

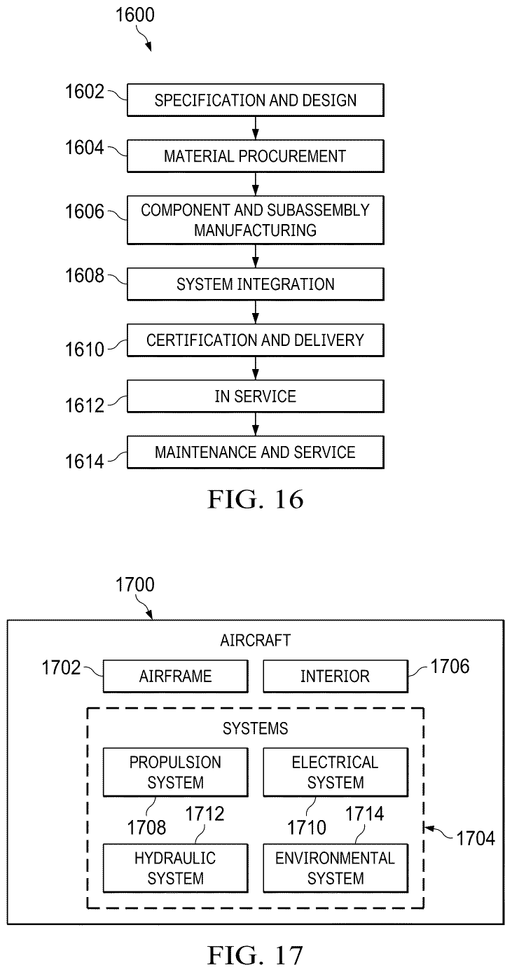

Illustrative embodiments of the present disclosure may be described in the context of aircraft manufacturing and service method 1600 as shown in FIG. 16 and aircraft 1700 as shown in FIG. 17. Turning first to FIG. 16, an illustration of an aircraft manufacturing and service method in a form of a block diagram is depicted in accordance with an illustrative embodiment. During pre-production, aircraft manufacturing and service method 1600 may include specification and design 1602 of aircraft 1700 in FIG. 17 and material procurement 1604.

During production, component and subassembly manufacturing 1606 and system integration 1608 of aircraft 1700 takes place. Thereafter, aircraft 1700 may go through certification and delivery 1610 in order to be placed in service 1612. While in service 1612 by a customer, aircraft 1700 is scheduled for routine maintenance and service 1614, which may include modification, reconfiguration, refurbishment, or other maintenance and service.

Each of the processes of aircraft manufacturing and service method 1600 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 17, an illustration of an aircraft in a form of a block diagram is depicted in which an illustrative embodiment may be implemented. In this example, aircraft 1700 is produced by aircraft manufacturing and service method 1600 of FIG. 16 and may include airframe 1702 with plurality of systems 1704 and interior 1706. Examples of systems 1704 include one or more of propulsion system 1708, electrical system 1710, hydraulic system 1712, and environmental system 1714. Any number of other systems may be included.

Apparatuses and methods embodied herein may be employed during at least one of the stages of aircraft manufacturing and service method 1600. One or more illustrative embodiments may be manufactured or used during at least one of component and subassembly manufacturing 1606, system integration 1608, in service 1612, or maintenance and service 1614 of FIG. 16.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A roller compactor comprising:
a first portion of a compaction surface formed of a first material; and
a second portion of the compaction surface formed of a second material having a lower hardness than the first material, wherein the second portion is configured to selectively reduce compaction pressure by the second portion of the compaction surface.

2. The roller compactor of claim 1, wherein the compaction surface is complementary to a cross-sectional shape of a composite member.

3. The roller compactor of claim 2, wherein the compaction surface is complementary to a forming surface of a forming tool.

4. The roller compactor of claim 1, wherein the second portion is selected to reduce compaction inconsistencies in a composite material compacted by rolling the roller compactor over the composite material.

5. The roller compactor of claim 4, wherein the second portion is selected to locally relax compaction outside of a concave radius of a cross-sectional shape of the composite material to intensify compaction in the concave radius.

6. The roller compactor of claim 1, wherein the first portion of the compaction surface comprises web forming surfaces, and wherein the second portion of the compaction surface comprises a cap forming surface.

7. The roller compactor of claim 6, wherein a size and a shape of the cap forming surface are configured to reduce bridging in an elongate composite member.

8. The roller compactor of claim 6, wherein a roller body comprises a trapezoidal cross-sectional shape including the web forming surfaces and the cap forming surface.

9. The roller compactor of claim 6 further comprising:
radiuses between the web forming surfaces and the cap forming surface, wherein the radiuses are formed of the first material.

10. The roller compactor of claim 1 further comprising adhesive between the first material and the second material.

11. The roller compactor of claim 1, wherein the second material is restrained against the first material by friction.

12. The roller compactor of claim 1 further comprising:
protrusions formed of the first material; and
channels in the second material positioned over the protrusions to secure the second material to the first material.

13. The roller compactor of claim 1, wherein the first material and the second material are configured to provide sufficient friction with a composite material being compacted to passively roll the roller compactor about a rotational shaft.

14. A method of compacting a composite material comprising:
rolling a roller compactor along a compaction path such that a compaction surface of the roller compactor is in contact with a composite material, the compaction surface comprising a first portion formed of a first material and a second portion formed of a second material having a lower hardness than the first material; and
applying a reduced compaction pressure to the composite material by the second portion of the compaction surface.

15. The method of claim 14, wherein applying the reduced compaction pressure to the composite material comprises applying a reduced compaction pressure between radiuses of a cross-sectional shape of the composite material.

16. The method of claim 14 further comprising:
identifying a first region of a cross-sectional shape of an elongate composite member to receive a higher compaction pressure; and
forming the first portion of the compaction surface configured to contact the first region of the cross-sectional shape out of the first material.

17. The method of claim 14 further comprising:
identifying a second region of a cross-sectional shape of an elongate composite member to receive the reduced compaction pressure; and
forming the second portion of the compaction surface using the second material wherein the second portion of the compaction surface is configured to contact the second region of the cross-section.

18. A method of controlling compaction pressure of a roller compactor comprising:
forming a first portion of a compaction surface of the roller compactor from a first material; and
forming a second portion of the compaction surface of the roller compactor from a second material having a lower hardness than the first material.

19. The method of claim 18 further comprising:
compacting an elongate composite member using the roller compactor, wherein compacting comprises applying a compaction pressure by the first material and applying a reduced compaction pressure by the second material.

20. The method of claim 18, wherein forming the second portion of the compaction surface comprises applying the second material over the first material.

21. The method of claim 20, wherein forming the second portion of the compaction surface further comprises adhering the second material to the first material using an adhesive.

22. The method of claim 20, wherein forming the second portion of the compaction surface further comprises forming mechanical connections between mechanical connectors of the first material and the second material.

23. The method of claim 18, wherein forming the first portion of the compaction surface comprises three-dimensionally printing the first portion of the compaction surface of the first material, and wherein forming the second portion of the compaction surface comprises three-dimensionally printing the second portion of the compaction surface of the second material.
